(19) United States
(12) Patent Application Publication
(10) Pub. No.: US 2019/0052096 A1
(43) Pub. Date: Feb. 14, 2019

(54) CONTROL DEVICE

(71) Applicant: NEC Corporation, Tokyo (JP)

(72) Inventor: Koji KUDO, Tokyo (JP)

(73) Assignee: NEC Corporation, Tokyo (JP)

(21) Appl. No.: 16/080,357

(22) PCT Filed: Feb. 29, 2016
(86) PCT No.: PCT/JP2016/056114

§ 371 Date: Aug. 28, 2018

(51) Int. Cl. H02J 3/46; H02J 7/00; G05B 15/02

(52) U.S. Cl. CPC H02J 3/46; G05B 15/02; H02J 7/0013

(57) ABSTRACT

To reduce a time lag when differential power from target values of outputs of a plurality of renewable energy power sources distributed in a wide area is absorbed by a plurality of energy storage devices distributed in a wide area, there is provided a control device (10) including a reception unit (101) that receives power generation relevant information related to a power generation situation of each of a plurality of power generation devices; a calculation unit (102) that calculates total differential power indicating a difference between a power generation output by the plurality of power generation devices and a target power generation output based on the received power generation relevant information; and a transmission unit (103) that transmits differential power information indicating the total differential power to a plurality of supply and demand adjustment control devices.

### TECHNICAL FIELD

The present invention relates to a control device, a supply and demand adjustment control device, a power storage device, an output control device, a supply and demand adjustment system, a control method, a supply and demand adjustment method, and a program.

### BACKGROUND ART

There are known power generation devices, such as photovoltaic power generation devices or wind power generation devices, generating power using renewable energy (hereinafter also referred to as “renewable energy power sources”). In recent years, renewable energy power sources connected to power systems have increased quickly.

Since outputs of renewable energy power sources fluctuate depending on weather, the outputs are not stable (cannot be planned). Therefore, when renewable energy power sources connected to a power system increase, it is difficult to keep a supply and demand balance of the power system. When a supply and demand balance in the power system collapses due to fluctuation in outputs of the renewable energy power sources, it is difficult to keep a frequency or a voltage of the power system within a predetermined range.

Therefore, a technology for alleviating the fluctuation in the outputs of the renewable energy power sources is requested. For example, a technology for suppressing rates of change of the outputs on the renewable energy power source sides so as to be kept within predetermined values (or ranges) was examined, and thus a technology related to Non-Patent Document 1 was disclosed.

A technology has been examined for suppressing differential power over a predetermined value in generated power of the renewable energy power sources during a period of time in which there is a concern of a power failure because a supply and demand balance considerably collapses beyond a level of a fluctuation in output (oversupply), and its related technology is disclosed in Patent Document 1.

Even for countermeasures for the fluctuation in the outputs of the renewable energy power sources and countermeasures for the differential power, it is not preferable to suppress generated power of the renewable energy power sources from the viewpoint of effective utilization of the renewable energy power sources. Accordingly, the present inventors have examined a method of absorbing “a difference from a target value (predetermined preferable value)” of generated power of the renewable energy power sources in real time by energy storage devices (for example, secondary batteries or heat pump water heaters).

The present inventors have examined a technology (hereinafter also referred to as an “examination technology”) for absorbing the difference above in all the plurality of renewable energy power sources distributed in a wide area in real time by a plurality of energy storage devices distributed in a wide area from the viewpoint of a possibility of a flexible scale change or effective utilization of renewable energy power sources or energy storage devices.

The absorption herein means, when an output of a renewable energy power source exceeds a target value, “the difference is charged by a secondary battery”, “the difference is consumed by a heat pump water heater”, or the like. In addition, the absorption herein means, when an output of a renewable energy power source is below a target value, “the difference is discharged from a secondary battery”, “charging equivalent to the difference is suppressed (a charging amount is reduced) when charging is in progress in a secondary battery”, “power consumption equivalent to the difference is suppressed (a consumption amount is reduced) when a heat pump water heater is operating”, or the like.

### RELATED DOCUMENT

### Patent Document

[Patent Document 1] Japanese Patent Application Publication No. 2013-5537

### Non-Patent Document

[Non-Patent Document 1] Toshiba Review, Vol.65 No.9 “Output Power Fluctuation Suppression Technology for Photovoltaic Power Generation System”, [online], [searched on Dec. 16, 2015], Internet <URL: https://www.toshiba.co.jp /tech/review/2010/09/65_09pdf/a04.pdf>

### SUMMARY OF THE INVENTION

### Technical Problem

However, when a supply and demand adjustment process is performed by calculating differential power reversely flowing to a power system from a plurality of renewable energy power sources distributed in a wide area and allocating differential power to be absorbed to a plurality of energy storage devices distributed in a wide area, control of the energy storage devices is delayed due to a delay in communication or a delay in processing, and it is difficult to absorb the differential power in the plurality of energy storage devices in real time with high accuracy. That is, there is a problem that a time lag occurs between a timing at which reverse power flow from the renewable energy power sources to the power system occurs and a timing at which the differential power is absorbed by the energy storage devices, a supply and demand balance of the power system is not kept, and therefore a fluctuation of the supply and demand balance occurs.

### Solution to Problem

According to an aspect of the invention, there is provided a control device including: a reception unit that receives power generation relevant information related to a power generation situation of each of a plurality of power generation devices; a calculation unit that calculates total differential power indicating a difference between a power generation output by the plurality of power generation devices and a target power generation output based on the received power generation relevant information; and a transmission unit that transmits differential power information indicating the total differential power to a plurality of supply and demand adjustment control devices.

According to another aspect of the invention, there is provided a supply and demand adjustment control device including: an adjustment-device-side reception unit that receives differential power information indicating total differential power which is a sum of differences between actually measured values of power generation outputs of a plurality of power generation devices and target power generation outputs of the power generation devices for each predetermined period; and a control unit that controls an energy storage device based on the differential power information.

According to still another aspect of the invention, there is provided a supply and demand adjustment system including the control device and the supply and demand adjustment control device.

According to still another aspect of the invention, there is provided a control method executed by a computer, the method including: a reception step of receiving power generation relevant information related to a power generation situation of each of a plurality of power generation devices; a calculation step of calculating total differential power indicating a difference between a power generation output by the plurality of power generation devices and a target power generation output based on the received power generation relevant information; and a transmission step of transmitting differential power information indicating the total differential power to a plurality of supply and demand adjustment control devices.

According to still another aspect of the invention, there is provided a program causing a computer to function as: a reception unit that receives power generation relevant information related to a power generation situation of each of a plurality of power generation devices; a calculation unit that calculates total differential power indicating a difference between a power generation output by the plurality of power generation devices and a target power generation output based on the received power generation relevant information; and a transmission unit that transmits differential power information indicating the total differential power to a plurality of supply and demand adjustment control devices.

According to still another aspect of the invention, there is provided a supply and demand adjustment method executed by a computer, the method including: an adjustment-device-side reception step of receiving differential power information indicating total differential power which is a sum of differences between actually measured values of power generation outputs of a plurality of power generation devices and target power outputs of the power generation devices for each predetermined period; and a control step of controlling an energy storage device based on the differential power information.

According to still another aspect of the invention, there is provided a program causing a computer to function as: an adjustment-device-side reception unit receives differential power information indicating total differential power which is a sum of differences between actually measured values of power generation outputs of a plurality of power generation devices and target power outputs of the power generation devices for each predetermined period; and a control unit that controls an energy storage device based on the differential power information.

According to still another aspect of the invention, there is provided a power storage device including the supply and demand adjustment control device and a secondary battery.

According to still another aspect of the invention, there is provided an output control device including: a reception unit that receives a target power generation output; and a transmission unit that transmits differential power indicating a difference between a power generation output and the target power generation output.

### Advantageous Effects of Invention

According to the present invention, it is possible to reduce a time lag when differential power from a target value of outputs of a plurality of renewable energy power sources distributed in a wide area is absorbed by a plurality of energy storage devices distributed in a wide area.

### BRIEF DESCRIPTION OF THE DRAWINGS

The above-described objects, other objects, characteristics, and advantages are further apparent from the following preferred example embodiments and the following appended drawings.

FIG. 1 is a diagram conceptually illustrating an example of a hardware configuration of a device according to an example embodiment.

FIG. 2 is a diagram illustrating an example of an overview and an overall picture of a supply and demand adjustment system according to the example embodiment.

FIG. 3 is a diagram illustrating an operational effect of the supply and demand adjustment system according to the example embodiment.

FIG. 4 is an exemplary functional block diagram illustrating a control device according to the example embodiment.

FIG. 5 is a diagram schematically illustrating an example of information registered in the control device according to the example embodiment.

FIG. 6 is a diagram schematically illustrating an example of information registered in the control device according to the example embodiment.

FIG. 7 is a diagram schematically illustrating an example of an instruction to suppress power generation according to the example embodiment.

FIG. 8 is a diagram schematically illustrating an example of an instruction to suppress power generation according to the example embodiment.

FIG. 9 is an exemplary functional block diagram illustrating a supply and demand adjustment control device according to the example embodiment.

FIG. 10 is a sequence diagram illustrating an example of a flow of a process of the supply and demand adjustment system according to the example embodiment.

FIG. 11 is a diagram illustrating a specific example of a process of the supply and demand adjustment system according to the example embodiment.

FIG. 12 is a diagram illustrating a specific example of a process of the supply and demand adjustment system according to the example embodiment.

FIG. 13 is a diagram illustrating an operational effect of the supply and demand adjustment system according to the example embodiment.

FIG. 14 is an exemplary functional block diagram illustrating a control device according to the example embodiment.

FIG. 15 is a diagram illustrating a specific example of a process of the supply and demand adjustment system according to the example embodiment.

FIG. 16 is a diagram illustrating an operational effect of the supply and demand adjustment system according to the example embodiment.

FIG. 17 is an exemplary functional block diagram illustrating a control device according to the example embodiment.

FIG. 18 is an exemplary functional block diagram illustrating a difference calculation unit according to the example embodiment.

FIG. 19 is an exemplary functional block diagram illustrating a supply and demand adjustment control device according to the example embodiment.

FIG. 20 is an exemplary functional block diagram illustrating a power generation device according to the example embodiment.

### DESCRIPTION OF EXAMPLE EMBODIMENTS

Hereinafter, example embodiments will be described. Functional block diagrams used to describe the following example embodiments illustrate blocks in functional units rather than configurations in hardware units. In these drawings, it is described that each device is configured by one device, but configuration method thereof is not limited thereto. That is, each device may be configured to be divided physically or may be configured to be divided logically. The same reference numerals are given to the same constituent elements and the description thereof will not be repeated appropriately.

### First Example Embodiment

In a supply and demand adjustment system according to the example embodiment, when a sum (W) of actually measured values of generated power of a plurality of renewable energy power sources is larger than a sum (W) of upper limit power generation outputs (target power generation outputs) of the plurality of renewable energy power sources, total differential power (W), which is the excess, is absorbed (charged and/or consumed) by a plurality of energy storage devices.

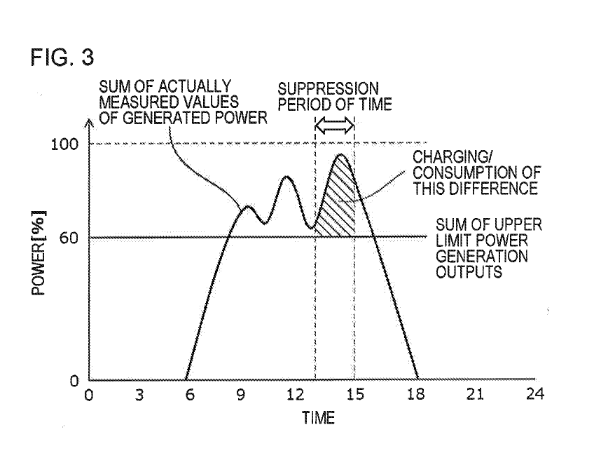

For example, as illustrated in FIG. 3, an upper limit power generation output of each of the plurality of renewable energy power sources is assumed to be determined to 60% of a rated output in a period of time of suppression in which an output upper limit is set. Then, a sum of actually measured values of power generation of the plurality of renewable energy power sources driven without suppressing power generation is assumed to be in a situation illustrated in the drawing. In this case, the supply and demand adjustment system according to the example embodiment, a total differential power amount (Wh) indicated by diagonal lines in the drawing is absorbed by the plurality of energy storage devices.

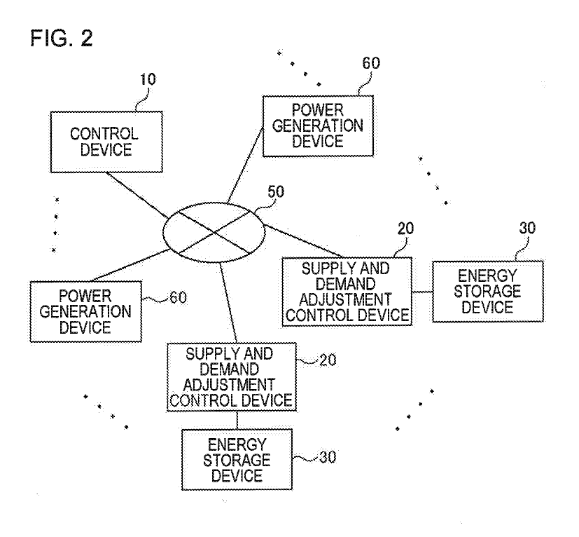

First, an overall picture of the supply and demand adjustment system according to the example embodiment will be described with reference to FIG. 2. The supply and demand adjustment system according to the example embodiment includes a control device 10 and a plurality of supply and demand adjustment control devices 20. An energy storage system (for example, secondary storage devices) may be configured by the supply and demand adjustment device 20 and an energy storage device 30 (for example, a secondary battery). The supply and demand adjustment system may include the energy storage system. The supply and demand adjustment system may include a plurality of power generation devices 60. These devices are connected to each other via a network 50 such as the Internet to transmit and receive information one another.

The control device 10 is, for example, a cloud server and performs a predetermined process. The power generation device 60 is a device that generates power using natural energy such as solar light, wind power, small hydro power, or terrestrial heat. The power generation device 60 corresponds to the above-described renewable energy power source. Any of all the configurations of the related art can be adopted for the power generation device 60. The power generation device 60 may be a large-scale power generation device (for example, mega solar power system) managed by a service provider or may be a small-scale power generation device managed at a general home.

The energy storage device 30 is configured to store supplied power as predetermined energy. For example, a secondary battery or an electric vehicle (a secondary battery mounted on an electric vehicle) that stores supplied power as power, a heat pump water heater that converts supplied power into thermal energy and stores the thermal energy, and the like can be considered, but the invention is not limited thereto. Any of all the configurations of the related art can be adopted for the energy storage device 30. The energy storage device 30 may be a large-scale energy storage device managed by a service provider or may be a small-scale energy storage device managed at a general home. The supply and demand control device 20 controls charging, discharging, and consumption of power performed by the energy storage device 30.

In the drawing, the supply and demand adjustment control device 20 and the energy storage device 30 are separately illustrated, but these devices may be configured to be divided physically and/or logically or may be configured to be integrated physically and/or logically.

Next, an overview of a process of the system performed in cooperation of the plurality of devices will be described. The supply and demand adjustment system according to the example embodiment ascertains the upper limit power generation output of each of the plurality of power generation devices 60 on the basis of instructions to suppress power generation, which is acquired from an electricity transmission and distribution service provider that manages electricity transmission and distribution of a power system. Then, a total differential power (a sum of pieces of power over the upper limit power generation outputs) in all the plurality of power generation devices 60 distributed in a wide area is absorbed (charged and/or consumed) by the plurality of energy storage devices 30 distributed in a wide area. Each device operates in the following manner. A suppression period of time specified by the instruction to suppress power generation and a period of time before the suppression period of time will be separately described.

Before the suppression period of time (for example, a previous day), the control device 10 acquires the instruction to suppress power generation for each of the plurality of power generation devices 60. In response to the acquisition, the control device 10 determines the energy storage devices 30 that perform a process of performing charging and/or consumption of the total differential power in the suppression period of time specified by the instruction to suppress power generation. Thereafter, the control device 10 determines a sharing ratio of each of the determined energy storage devices 30 and transmits a sharing coefficient indicating the determined sharing ratio to each of the supply and demand adjustment control devices 20.

In the suppression period of time, each of the plurality of power generation devices 60 repeatedly transmits power generation relevant information related to a power generation situation (for example, the actually measured value (W) of the power generation output) to the control device 10. The control device 10 calculates the total differential power (W) in all the plurality of power generation devices 60 on the basis of the power generation relevant information and the upper limit power generation outputs in the instruction to suppress power generation acquired before the suppression period of time. Then, the control device 10 transmits differential power information related to the calculated total differential power to the plurality of supply and demand adjustment control devices 20. The control device 10 repeatedly performs the calculation and the transmission.

When each of the plurality of supply and demand adjustment control devices 20 receives the differential power information related to the total differential power (W), the supply and demand adjustment control device 20 calculates a share (W) indicated by the sharing coefficient in the total differential power (W) on the basis of the differential power information and the sharing coefficient received before the suppression period of time. Then, the share is determined as charging power and/or consumption power of the corresponding energy storage device 30. Each of the plurality of supply and demand adjustment control devices 20 causes each energy storage device 30 to perform charging and/or consumption of the determined charging power and/or consumption power. The supply and demand adjustment control device 20 repeatedly performs this process. An operation control unit charges and/consumes power with the determined charging power (W)/consumption power (W) for a period T1b until new differential power information is received.

In other words, a charging power amount (Wh)/consumption power amount (Wh) for the period T1b until the new differential power information is received is a value of charging power (W)/consumption power (W)×T1b.

Next, the configuration of the control device 10 and each of the supply and demand adjustment control devices 20 which are characteristics of the system will be described in detail.

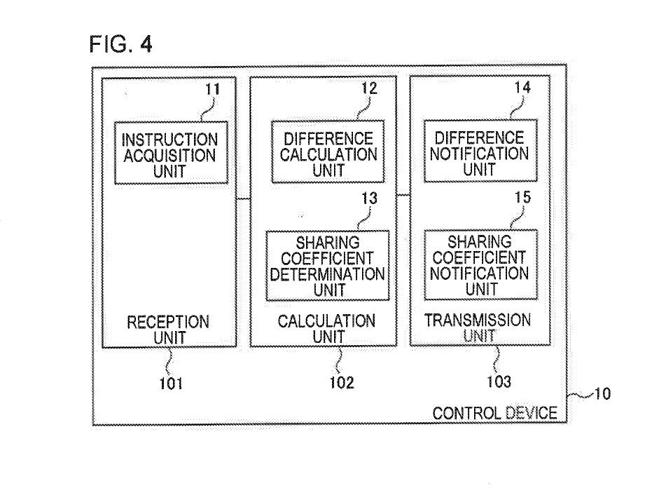

FIG. 4 is an exemplary functional block diagram illustrating the control device 10. As illustrated in the drawing, the control device 10 includes a reception unit 101, a calculation unit 102, and a transmission unit 103. The reception unit 101 includes an instruction acquisition unit 11. The calculation unit 102 includes a difference calculation unit 12 and a sharing coefficient determination unit 13. The transmission unit 103 includes a difference notification unit 14 and a sharing coefficient notification unit 15. The difference notification unit 14 and the sharing coefficient notification unit 15 can perform communication via the same communication unit.

First, the plurality of power generation devices 60 and the plurality of energy storage devices 30 which are to be managed are registered in the control device 10. The control device 10 causes the plurality of energy storage devices 30 to be managed to perform charging and/or consumption of the total differential power of the plurality of power generation devices 60 to be managed.

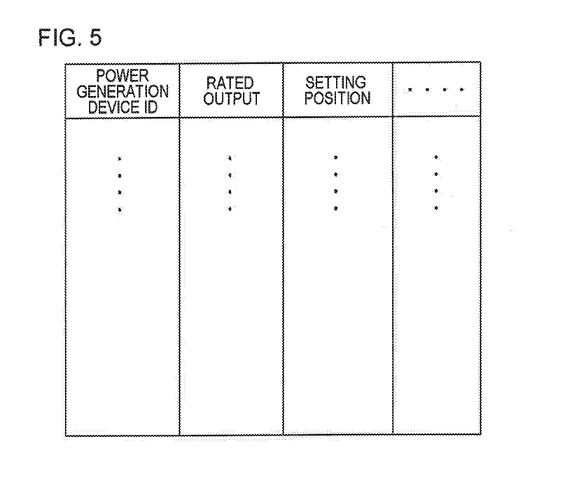

For example, attribute information of each of the power generation devices 60 illustrated in FIG. 5 is registered in advance in the control device 10. In FIG. 5, a power generation device identification (ID) for identifying each of the plurality of power generation devices 60, a rated output (W) of each power generation device 60, and a setting position of each power generation device 60 are associated with each other. The rated output (W) mentioned herein is an upper limit of a reverse power flow for each photovoltaic power generation device determined in accordance with a total number of installed photovoltaic panels or power conditioners when the power generation device 60 is, for example, a photovoltaic power generation device. A part of the information may not be included as the attribute information and other attribute information may be further registered.

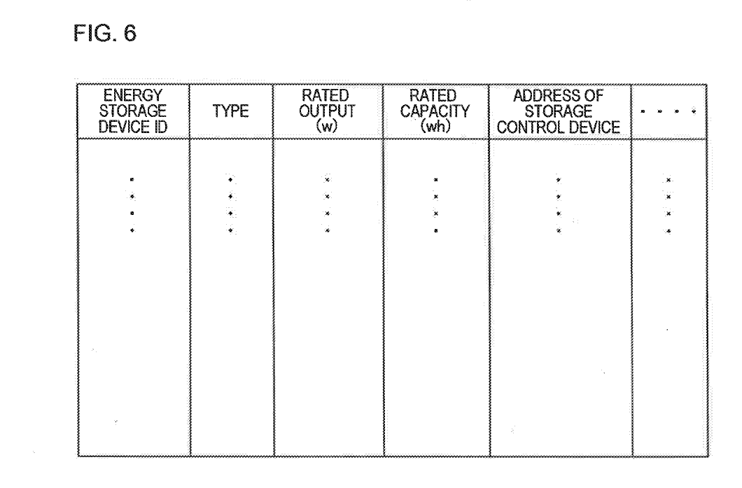

For example, attribute information of each energy storage device 30 illustrated in FIG. 6 is registered in advance in the control device 10. In FIG. 6, an energy storage device ID for identifying each of the plurality of energy storage devices 30, a type of each energy storage device 30, a rated output (W) of each energy storage device 30, a rated capacity (Wh) of each energy storage device 30, and an address information of the supply and demand control device 20 controlling each energy storage device 30 on the network 50 are associated with other. A part of the information may not be included as the attribute information and other attribute information may be further registered.

The type illustrated in FIG. 6 indicates, for example, classification in associated with an energy storage unit such as a secondary battery or a heat pump water heater, a type of storage cell such as a lead secondary battery or a lithium ion secondary battery, charging and discharging response characteristics of the secondary battery and the like. When the energy storage device 30 registered as management objects are limited to one type (for example, only lithium ion second batteries), it is not necessary to register this attribute information.

Referring back to FIG. 4, the reception unit 101 receives predetermined information from an external device. The instruction acquisition unit 11 acquires an instruction to suppress power generation which is an instruction for the power generation device 60 generating power using natural energy and which includes an upper limit power generation output for each suppression period of time and each unit period of time (for example, 30 minutes). The instruction acquisition unit 11 acquires the instruction to suppress power generation for the power generation device 60 to be managed.

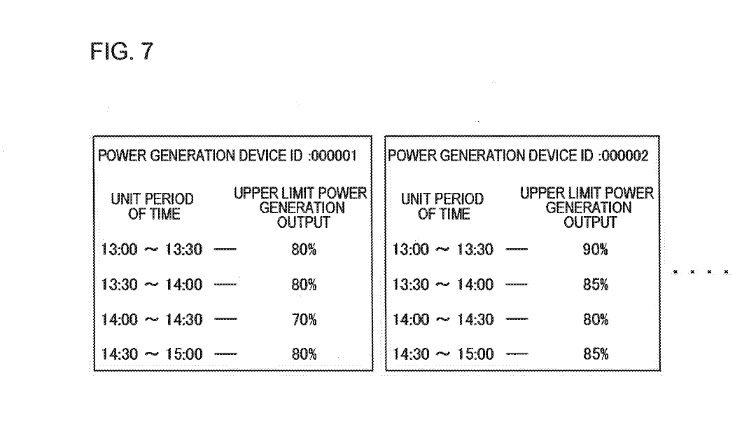

The instruction to suppress power generation may have different content for each power generation device 60. FIG. 7 schematically illustrates an example of the instruction to suppress power generation. FIG. 7 illustrates the instruction to suppress power generation for each power generation device 60 (each power generation device ID).

In the instruction to suppress power generation for each power generation device 60, an upper limit power generation output for each unit period of time is indicated. In the example illustrated in the drawing, the upper limit power generation output is indicated in units of 30 minutes. In addition, the upper limit power generation output is indicated at a ratio when a rated output (W) of each power generation device 60 is 100 (%). From the drawing, it can be understood that the upper limit power generation output in each unit period of time is different for each power generation device 60.

In the example illustrated in the drawing, the suppression periods of time of two power generation devices 60 are identical to each other, from 13:00 to 15:00, but the suppression period of time may be different for each power generation device 60. The power generation devices 60 receiving the instruction to suppress power generation and the power generation devices 60 not receiving the instruction to suppress power generation may coexist among the power generation devices 60 to be managed.

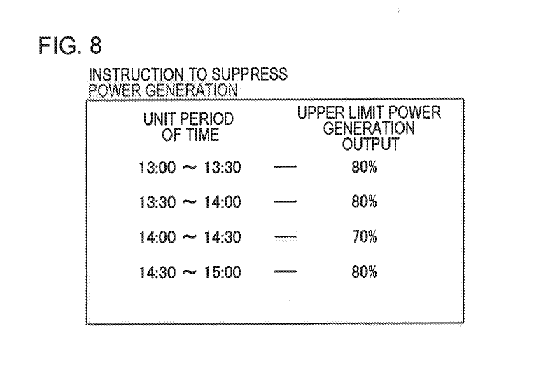

As another example of the instruction to suppress power generation, the content of the instruction to suppress power generation may be common to the plurality of power generation devices 60. FIG. 8 schematically illustrates an example of the instruction to suppress power generation. FIG. 8 illustrates the instruction to suppress power generation without being separated for each power generation device 60. Even in the case of this example, the power generation devices 60 receiving the instruction to suppress power generation and the power generation devices 60 not receiving the instruction to suppress power generation may coexist among the power generation devices 60 to be managed. In this case, the instruction acquisition unit 11 acquires information for identifying the power generation device 60 which is an object of the instruction to suppress power generation in addition to the instruction to suppress power generation illustrated in FIG. 8.

In the examples illustrated in FIGS. 7 and 8, the unit period of time is set to the units of 30 minutes, but the unit period of time may be set to other units such as units of 1 hour, units of 15 minutes, and units of 5 minutes. In the examples illustrated in the drawings, the upper limit power generation output is indicated at the ratio (%) of each power generation device 60 to the rated output, but the upper limit output may be indicated by the output value (for example, 400 kW).

The above-described instruction to suppress power generation is generated by, for example, a system of an electricity transmission and distribution service provider managing electricity transmission and distribution of a power system (hereinafter also referred to as a “electricity transmission and distribution service provider system”) and is transmitted to a predetermined object person. Since the process by the electricity transmission and distribution service provider system can be implemented in conformity to a technology of the conventional art, the detailed description thereof will not be repeated herein. An exemplary overview of the process is as follows.

The electricity transmission and distribution service provider system performs power demand prediction for the following one day, power generation prediction for the power generation devices 60 connected to the power system, or the like on the basis of attribute information (for example, weather forecast, a date, a day of week, and an event) of the following day. Then, on the basis of the prediction necessity of power generation suppression, a period of time in which the power generation suppression is performed, a district in which the power generation suppression is performed, the power generation devices 60 as objects of the power generation suppression, a total amount of suppression (for each unit period of time), a suppression amount of each power generation device 60 (for each unit period of time), and the like are determined. Then, the electricity transmission and distribution service provider system transmits the instruction to suppress power generation to predetermined objects at a predetermined timing (for example, a predetermined time of the previous day).

For example, the electricity transmission and distribution service provider system may transmit the instruction to suppress power generation for each of the plurality of power generation devices 60 registered in the control device 10, to the control device 10. In this case, the instruction acquisition unit 11 receives the instruction to suppress power generation from the electricity transmission and distribution service provider system.

Conversely, the electricity transmission and distribution service provider system may transmit the instruction to suppress power generation to each of the plurality of the power generation devices 60. In this case, the instruction acquisition unit 11 receives the instruction to suppress power generation from each of the plurality of power generation devices 60 to be managed.

Referring back to FIG. 4, the calculation unit 102 performs a calculation process on the basis of predetermined data to calculate predetermined data. The sharing coefficient determination unit 13 determines a sharing coefficient indicating a sharing ratio for an absorbing process of performing charging or consumption of power equivalent to the total differential power (W) for each of the plurality of energy storage devices 30 performing the absorbing process in the suppression period of time. The sharing coefficient determination unit 13 determines the sharing coefficient before the absorbing process is started.

The sharing coefficient determination unit 13 performs “a process of determining the energy storage device 30 performing the absorbing process” and “a process of determining the sharing ratio (the sharing coefficient) of the determined energy storage device 30”.

First, “the process of determining the energy storage device 30 performing the absorbing process” will be described. The sharing coefficient determination unit 13 determines the energy storage device 30 participating in the absorbing process from among the plurality of energy storage devices 30 registered in advance.

For example, all the energy storage devices 30 registered in advance may participate in all the absorbing processes and perform a process of performing charging and/or consumption of the total differential power. In this case, the sharing coefficient determination unit 13 determines all the energy storage devices 30 registered in advance as the energy storage devices 30 participating in the absorbing process.

As another example, at least some of the plurality of energy storage devices 30 registered in advance may participate in the absorbing processes and perform the process of performing charging and/or consumption of the total differential power. In this case, the sharing coefficient determination unit 13 determines at least some of the energy storage devices 30 participating in each time of the absorbing process from among the plurality of energy storage devices 30 registered in advance.

Here, the concept of “the absorbing process of one time” will be described. For example, the absorbing process (in the case of the example of FIG. 7, the absorbing process from 13:00 to 15:00 in FIG. 7) corresponding to one instruction to suppress power generation (for example, the instruction to suppress power generation equivalent to the following one day) may be treated as one time.

In addition, the absorbing process (in the case of the example of FIG. 7, the absorbing process from 13:00 to 15:00 in FIG. 7) corresponding to one instruction to suppress power generation (for example, the instruction to suppress power generation equivalent to the following one day) may be divided into the plurality of absorbing processes and each of the divided absorbing processes may be treated as one time. For example, in the case of the example of FIG. 7, the absorbing process at 13:00 to 14:00 may be treated as one time and the absorbing process at 14:00 to 15:00 may be treated as one time.

In addition, the sharing coefficient determination unit 13 may treat the absorbing process for plural instructions to suppress power generation as one time.

Next, a method in which the sharing coefficient determination unit 13 determines at least some of the energy storage devices 30 participating in the absorbing process of each time will be described. When the participating energy storage devices 30 are determined, the number of participating energy storage devices 30 is determined.

As one example, rotation is determined in advance and the plurality of energy storage devices 30 may participate in the absorbing process in sequence according to the rotation. In this case, the sharing coefficient determination unit 13 determines at least some of the energy storage devices 30 participating in the absorbing process of each time on the basis of the rotation.

As another example, a user managing each of the plurality of energy storage devices 30 may determine a participation condition of the absorbing process in advance and register the participation condition in the control device 10. As the condition, for example, a seasonal condition (for example, participation in March to August and non-participation in the other months), a time condition (for example, participation in 9:00 to 17:00 and non-participation in other hours), and other conditions (for example, participation when a total time is within 2 hours and non-participation when the total time is greater than 2 hours) can be considered, but the invention is not limited thereto.

In this case, the sharing coefficient determination unit 13 determines at least some of the energy storage devices 30 in which the participation conditions are satisfied from among the plurality of energy storage devices 30 registered in advance.

In addition, the control device 10 may recruit the users managing the plurality of energy storage devices 30 participating in the absorbing process at each time. In this case, the sharing coefficient determination unit 13 determines the energy storage devices 30 of the users who have expressed the participation as the energy storage devices 30 participating in the absorbing process of each time. The recruitment may be performed using a communication mechanism such as electronic mails, bulletin board systems on the network 50, or social media.

Next, “the process of determining the sharing ratio (the sharing coefficient) of the determined energy storage device 30” Will be described. After the energy storage devices 30 participating in the absorbing process are determined, the sharing coefficient determination unit 13 determines the sharing coefficient (the sharing ratio) for each of the participating energy storage devices 30. The sharing coefficient determination unit 13 determines the sharing coefficient through the following method, for example.

First, the user managing each of the plurality of energy storage devices 30 can determine a use condition of the energy storage device 30 in the absorbing process. The use condition is, for example, an output upper limit (for example, usable up to 2 kW) usable in the absorbing process or a capacity upper limit (for example, usable up to 6 kWh) usable in the absorbing process. The use condition may be determined for each absorbing process of each time.

For example, the sharing coefficient determination unit 13 determines the sharing coefficient on the basis of the use condition or the specification of each energy storage device 30 (see FIG. 6). For example, the sharing coefficient determination unit 13 determines the sharing coefficient which is a heavier sharing ratio for the energy storage device 30 in which the usable output upper limit or the usable capacity upper limit is large. A specific calculation method is a design factor. For example, the sharing coefficient in one energy storage device 30 may be a ratio of a capacity usable in the one energy storage device 30 to the whole usable capacity of the plurality of energy storage devices 30 determined to participate in the absorbing process.

The sharing coefficient indicates a sharing ratio of each energy storage device 30 to the total differential power. The sharing coefficient may be expressed as percentages. In the case of this example, the energy storage device 30 in which the sharing coefficient of, for example, “0.05” is determined charges and/or consumes with an output of 5% of the total differential power during the absorbing process.

In addition, the sharing coefficient may be a value obtained by normalizing a percentage value as mentioned above. For example, a value obtained by multiplying the percentage value by a predetermined value M (a value equal to or larger than the upper limit of the total differential power (W)) may be the sharing coefficient. An example of the normalization will be described on the basis of the following specific example.

The sharing coefficient determination unit 13 may determine the sharing coefficient before the start of each unit period of time, for each unit time of the suppression period of time.

Referring back to FIG. 4, the transmission unit 103 transmits predetermined information to an external device. The sharing coefficient notification unit 15 transmits the sharing coefficient of each of the energy storage devices 30 determined by the sharing coefficient determination unit 13 to each of the plurality of supply and demand adjustment control devices 20 controlling an operation of each of the energy storage devices 30. The sharing coefficient may be transmitted in association with information for identifying the absorbing process in which the sharing coefficient is effective. For example, the sharing coefficient may be transmitted in association with an effective period, like “13:00 to 15:00, Dec. 4, 2015”.

A transmission timing of the sharing coefficient is any timing after the sharing coefficient is determined by the sharing coefficient determination unit 13 and before the absorbing process is started.

The sharing coefficient notification unit 15 successively transmits the sharing coefficient with content for each of the energy storage devices 30 to each of the plurality of supply and demand adjustment control devices 20 corresponding to each of the plurality of energy storage devices 30 determined to participate in the absorbing process. The sharing coefficient notification unit 15 may transmit the sharing coefficient set for each unit time of the suppression period of time.

The difference calculation unit 12 repeatedly calculates the total differential power (W) on the basis of actually measured values of the power generation outputs of the plurality of power generation devices 60 in the suppression period of time. The total differential power is an amount by which “a sum (W) of actually measured values of power generation outputs of the plurality of power generation devices 60” is larger than “a sum (W) of upper limit power generation outputs of the plurality of power generation devices 60”.

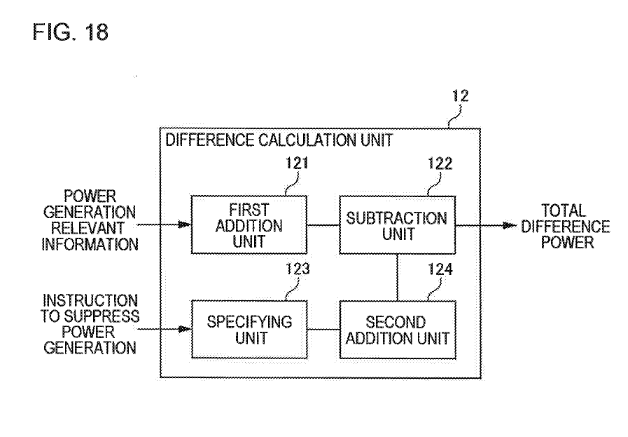

FIG. 18 is an exemplary functional block diagram illustrating the difference calculation unit 12. As illustrated in the drawing, the difference calculation unit 12 includes a first addition unit 121, a subtraction unit 122, a specifying unit 123, and a second addition unit 124.

First, the reception unit 101 (see FIG. 4) receives power generation relevant information (power generation output: actually measured value) related to each power generation situation from each of the plurality of power generation devices 60 for each predetermined period T1a.

For example, each of the plurality of power generation devices 60 repeatedly acquires data of a power generation Output (instantaneous value (W)) of each power generation device 60 measured at a predetermined time interval (for example, 400 msec) through real-time processing in the suppression period of time. Then, each of the plurality of power generation devices 60 repeatedly transmits the measured value to the control device 10 at a period T1a (for example, 10 sec) longer than the time interval. For example, the power generation device 60 transmits a representative value (for example, an average value, a maximum value, a minimum value, a mode, or a median value) of the plurality of measured values obtained during the period T1a to the control device 10.

Each of the plurality of power generation devices 60 transmits the measured values to the control device 10 by shifting a timing by a time less than the period T1a so that mutually transmitted data is not congested.

The first addition unit 121 acquires the power generation relevant information received by the reception unit 101. Then, the first addition unit 121 calculates a sum of the power generation outputs (the actually measured values) of the plurality of power generation devices 60. The first addition unit 121 repeatedly calculates “the sum of the power generation outputs (the actually measured values of the power generation outputs) of the plurality of power generation devices 60”, for example, at the same period of the period T1a.

The specifying unit 123 acquires the instruction to suppress power generation, which is acquired by the instruction acquisition unit 11. Thereafter, the specifying unit 123 specifies a target power generation output (the upper limit power generation output) of each power generation device 60. The upper limit power generation output of the power generation device 60 receiving the instruction to suppress power generation is an upper limit power generation output determined in the instruction to suppress power generation. Normally, the power generation device 60 not receiving the instruction to suppress power generation is not an object of the process of specifying the target power generation output (the upper limit power generation output). However, when the power generation device 60 not receiving the instruction is set as the object, the upper limit power generation output of the power generation device 60 not receiving the instruction to suppress power generation is, for example, a rated output. The second addition unit 124 calculates a sum of the target power generation outputs (the upper limit power generation outputs) of the plurality of power generation devices 60.

The specifying unit 123 may specify the upper limit power generation output of each of the plurality of power generation devices 60 for each unit period of time determined in the instruction to suppress power generation. Then, the second addition unit 124 may calculate “the sum of the upper limit power generation outputs of the plurality of power generation devices 60” for each unit period of time.

The subtraction unit 122 repeatedly calculates a difference (total difference) between the sum of the power generation outputs (the actually measured values) of the plurality of power generation devices 60 calculated by the first addition unit 121 and the sum of the target power generation outputs (the upper limit power generation outputs) of the plurality of power generation devices 60 calculated by the second addition unit 124 at a predetermined period T1. When the second addition unit 124 calculates “the sum of the upper limit power generation outputs of the plurality of power generation devices 60” for each unit period of time, the subtraction unit 122 calculates the total differential power using “the sum of the upper limit power generation outputs of the plurality of power generation devices 60” in a corresponding period of time.

Referring back to FIG. 4, the difference notification unit 14 repeatedly transmits differential power information indicating the total differential power to the plurality of supply and demand adjustment control devices 20 corresponding to the plurality of energy storage devices 30 determined to participate in the absorbing process in the suppression period of time. The differential power information may be a value of the total differential power (W) calculated by the difference calculation unit 12 or may be a value obtained by normalizing the value. For example, a value obtained by dividing the total differential power (W) by a predetermined value M (a value equal to or larger than the upper limit of the total differential power (W)) may be set as the normalized value. The predetermined value M is the same value as the predetermined value M used to normalize the above-described sharing coefficient. An example of the normalization will be described on the basis of the following specific example.

The difference notification unit 14 repeatedly transmits the differential power information indicating the total differential power repeatedly calculated by the difference calculation unit 12 to the power generation device 60 at a period T1b (T1b≥T1a). Basically, T1a=T1b is set. However, a process of predicting the total differential power is performed and T1b>T1a may be true. The power generation relevant information transmitted from each power generation device 60 to the control device 10 may be transmitted via another server without being directly transmitted.

Incidentally, the differential power information transmitted to the plurality of supply and demand adjustment control devices 20 has the same content. Therefore, the difference notification unit 14 can simultaneously transmit the differential power information with the same content to the plurality of supply and demand adjustment control devices 20. A scheme of performing the simultaneous transmission is, for example, multicast or broadcast in which FM communication or the like is used. Another scheme can also be used.

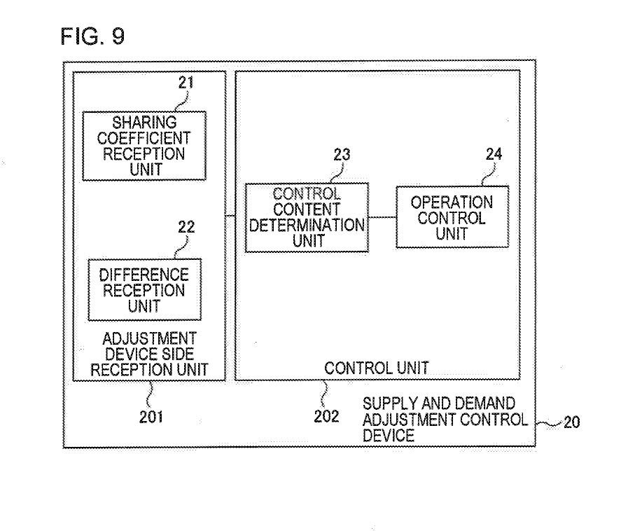

Next, the configuration of the supply and demand adjustment control device 20 will be described. FIG. 9 is an exemplary functional block diagram illustrating the supply and demand adjustment control device 20. As illustrated in the drawing, the supply and demand adjustment control device 20 includes an adjustment-device-side reception unit 201 and a control unit 202. The adjustment-device-side reception unit 201 includes a sharing coefficient reception unit 21 and a difference reception unit 22. The control unit 202 includes a control content determination unit 23 and an operation control unit 24. The sharing coefficient reception unit 21 and the difference reception unit 22 can perform communication via the same communication unit.

The adjustment-device-side reception unit 201 receives predetermined information from an external device. The sharing coefficient reception unit 21 receives the sharing coefficient individually transmitted to each of the plurality of supply and demand adjustment control devices 20 by the sharing coefficient notification unit 15, before the absorbing process is started. The adjustment-device-side reception unit 201 may receive the sharing coefficient set for each unit time of the suppression period of time.

The difference reception unit 22 receives the differential power information simultaneously transmitted to the plurality of power generation devices 60 by the difference notification unit 14, in the suppression period of time. The difference reception unit 22 repeatedly receives the differential power information repeatedly transmitted at the period T1b by the difference notification unit 14.

The control unit 202 performs a predetermined process on the basis of predetermined data. The control content determination unit 23 determines control content of the corresponding energy storage device 30 on the basis of the sharing coefficient received by the sharing coefficient reception unit 21 and the latest differential power information received by the difference reception unit 22. Specifically, charging power (W) and/or consumption power (W) of the energy storage device 30 is determined. When the difference reception unit 22 repeatedly receives the differential power information, the control content determination unit 23 accordingly repeatedly determines the charging power and/or consumption power.

For example, the sharing coefficient indicates the sharing ratio of each energy storage device 30 to the total differential power by percentage (for example, “0.05”). When the differential power information is the value (W) of the total difference power, the control content determination unit 23 can determine a product of the total differential power and the sharing coefficient as the charging power (W)/consumption power (W). Even when the sharing coefficient is normalized in the above-described way, the control content determination unit 23 can determine the product of the sharing coefficient and the differential power information (the value obtained by normalizing the total differential power) indicating the total differential power as the charging power (W)/consumption power (W). An example of the normalization will be described on the basis of the following specific example.

The operation control unit 24 controls the energy storage device 30 to perform the absorbing process in the suppression period of time. The operation control unit 24 causes the energy storage device 30 to perform charging and/or consumption of power with the charging power and/or consumption power determined by the control content determination unit 23. As described above, the control content determination unit 23 repeatedly determines the charging power and/or consumption power during the suppression period of time. When the control content determination unit 23 determines new charging power and/or consumption power, the operation control unit 24 causes the energy storage device 30 to perform charging and/or consumption of power with the newly determined charging power and/or consumption power. The operation control unit 24 causes the energy storage device 30 to perform charging and/or consumption of power with the determined charging power (W)/consumption power (W) for the period T1b until new differential power information is received. In other words, the charging power amount (Wh)/consumption power amount (Wh) in the period T1b until new differential power information is received is a value of charging power (W)/consumption power (W)×T1b.

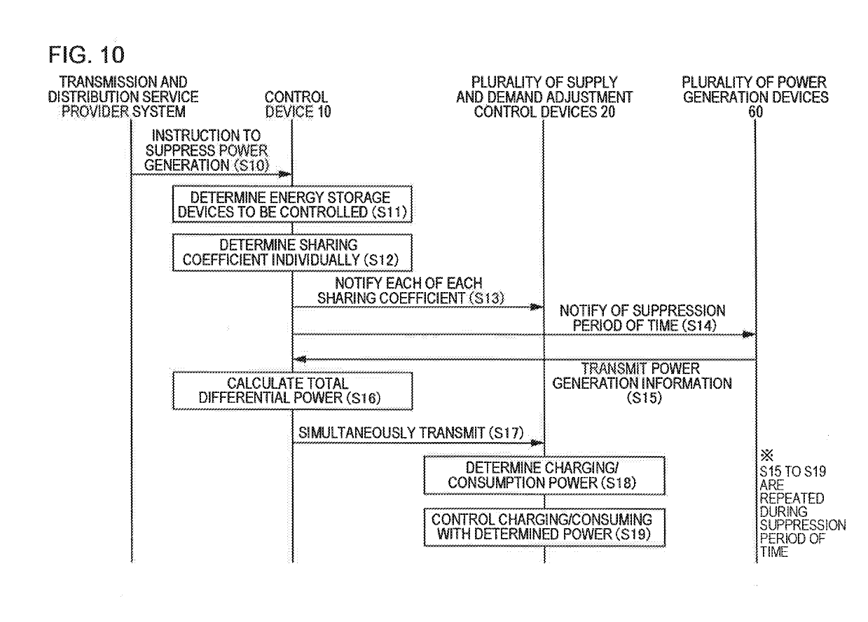

Next, an example of a flow of a process of the supply and demand adjustment system according to the example embodiment will be described with reference to the sequence diagram of FIG. 10.

First, the electricity transmission and distribution service provider system performs, for example, on the basis of attribute information (for example, weather forecast, a date, a day of week, and an event) of the following day, power demand prediction and power generation prediction for the power generation devices 60 connected to the power system, or an activation-stopping plan of generators of a thermal power plant or the like connected to the power system for the following one day. Then, on the basis of information such as the prediction, necessity of power generation suppression, a period of time in which the power generation suppression is performed, a district in which the power generation suppression is performed, the power generation devices 60 as objects, a total amount of suppression (for each unit period of time), a suppression amount of each power generation device 60 (for each unit period of time), and the like are determined. Then, the electricity transmission and distribution service provider system transmits the instruction to suppress power generation for the following day to predetermined objects at a predetermined timing (for example, a predetermined time of the previous day).

The instruction to suppress power generation includes the suppression period of time and the upper limit power generation output for each unit period of time (see FIGS. 7 and 8).

In the sequence diagram of FIG. 10, the electricity transmission and distribution service provider system transmits the instruction to suppress power generation for the plurality of power generation devices 60 registered in the control device 10 to the control device 10. In this transmission example, when the instruction to suppress power generation which is common to the plurality of energy storage devices 30 illustrated in FIG. 8 is transmitted, the electricity transmission and distribution service provider system transmits information for identifying the power generation device 60 which is an object of the instruction to suppress power generation to the control device 10 in addition to the instruction to suppress power generation.

The electricity transmission and distribution service provider, system may also transmit the instruction to suppress power generation to each of the plurality of power generation devices 60 which are power generation suppression objects. In this case, the instruction to suppress power generation is transmitted from each power generation device 60 to the control device 10.

In S11, the control device 10 determines the energy storage devices 30 which participate in the absorbing process in response to the instruction to suppress power generation acquired in S10. A specific example of the determination process has been described above.

For example, the control device 10 recruits the users managing the plurality of registered energy storage devices 30 so that the users participate in the absorbing process. Then, the control device 10 determines the energy storage devices 30 of the users who have expressed the participation as the energy storage devices 30 participating in the absorbing process.

In S12, the control device 10 determines the sharing coefficient for each of the energy storage devices 30 determined in S11. A specific example of the process of determining the sharing coefficient has been described above.

For example, a use condition (a usable output upper limit, a usable capacity upper limit, or the like) at the time of the absorbing process may also be determined for each energy storage device 30. On the basis of the use condition, the control device 10 may determine the sharing coefficient. For example, the sharing coefficient indicating a heavier sharing ratio may be determined for the energy storage device 30 in which the output upper limit or the capacity upper limit is large.

The control device 10 may determine the sharing coefficient of each of the plurality of supply and demand adjustment control devices 20 for each unit period of time of the suppression period of time.

In S13, the control device 10 transmits the sharing coefficient of each of the plurality of energy storage devices 30 determined in S12 to the supply and demand adjustment control device 20 controlling each of the energy storage devices 30 to be controlled.

In S14, the control device 10 notifies each of the plurality of power generation devices 60 of the suppression period of time specified by the instruction to suppress power generation, which is acquired in S10. S14 may not be performed. For example, S14 may not be performed when the power generation device 60 normally transmits the power generation relevant information to the control device 10 irrespective of the instruction to suppress power generation.

The process described above is performed before the suppression period of time specified by the instruction to suppress power generation, which is acquired in S10. S13 is preferably performed before the suppression period of time, but may be performed in the beginning of the suppression period of time.

S15 to S19 to be described below are performed in the suppression period of time. S15 to S19 are repeatedly performed during the period of time of suppression. The power generation suppression for the power veneration device 60 is not performed during the suppression period of time.

In S15, each of the plurality of power generation devices 60 repeatedly transmits the actually measured value (the instantaneous value (W)) of the power generation output to the control device 10 at the period T1a. For example, the actually measured value of the power generation output is measured at a time interval (for example, 400 msec) less than the period T1a and a representative value (for example, an average value, a maximum value, a minimum value, a mode, or a median value) of the plurality of actually measured values (W) obtained during the period T1a may be transmitted to the control device 10.

The plurality of power generation devices 60 transmit the actually measured values of the power generation outputs by shifting a timing by a time less than the period T1a so that mutually transmitted data is not congested.

In S16, the control device 10 repeatedly calculates the total differential power at a predetermined period. The total differential power is calculated on the basis of the actually measured values of the power generation outputs of the plurality of power generation devices 60 acquired repeatedly in S15. The total differential power is an amount by which the sum of actually measured values of power generation outputs of the plurality of power generation devices 60 is larger than the sum of upper limit power generation outputs of the plurality of power generation devices 60. A method of calculating the total differential power has been described above.

In S17, the control device 10 repeatedly transmits the differential power information indicating the total differential power to the plurality of supply and demand adjustment control devices 20 at the period T1b. The control device 10 may simultaneously transmit the differential power information with the same content to the plurality of supply and demand adjustment control devices 20 using a scheme such as multicast. The scheme of performing the simultaneous transmission is not limited to multicast and another scheme such as broadcast in which FM communication or the like may also be used.

In S18, each of the plurality of supply and demand adjustment control devices 20 repeatedly determines charging power and/or consumption power of each supply and demand adjustment control device 20 in the absorbing process on the basis of the sharing coefficient received in S13 and the differential power information (latest differential power information) received repeatedly in S17. The supply and demand adjustment control device 20 determines new charging power and/or consumption power on the basis of the new differential power information whenever the new differential power information is acquired.

For example, the sharing coefficient indicates the sharing ratio of each energy storage device 30 to the total differential power by percentage (for example, “0.05”). When the differential power information is the value (W) of the total difference power, the control content determination unit 23 may determine a product of the total differential power and the sharing coefficient as the charging power (W)/consumption power (W).

When the sharing coefficient is determined for each unit period of time of the suppression period of time, the supply and demand adjustment control device 20 determines the charging power and/or consumption power using the sharing coefficient of the unit period of time including a current time.

In S19, each of the plurality of supply and demand adjustment control devices 20 controls each of the plurality of energy storage devices 30 such that the charging and/or consumption of power with the latest charging power and/or consumption power determined in S18 is performed. The operation control unit 24 performs the charging and/or consumption of power with the determined charging power (W)/consumption power (W) for the period T1b until the new differential power information is received. In other words, the charging power amount (Wh)/consumption power amount (Wh) in the period T1b until the new differential power information is received is the value of charging power (W)/consumption power (W)×T1b.

Next, a specific instance will be described according to the flow of FIG. 10.

In S10, the control device 10 is assumed to acquire the instruction to suppress power generation, as illustrated in FIG. 8, for 10 power generation devices 60 with a rated output of 500 kW and 5 power generation devices 60 with a rated output of 400 kW.

Subsequently, in S11, the control device 10 determines the energy storage devices 30 participating in the absorbing process in response to the instruction to suppress power generation.

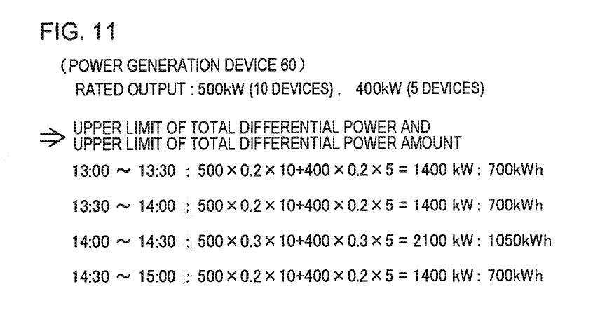

When the 15 power generation devices 60 receive the instruction to suppress power generation, as illustrated in FIG. 8, the upper limit of the total differential power (W) and the upper limit of the total differential power amount (Wh) in each unit period of time of the suppression period of time are calculated as in FIG. 11.

A calculation formula will be described exemplifying a unit period of time from 13:00 to 13:30. From FIG. 8, the upper limit power generation output in the unit period of time is 80% of the rated output. Therefore, the maximum value of the differential power in the unit period of time is 20% of the rated output. By adding up 20% of the rated outputs of the power generation devices 60, it is possible to calculate an upper limit of the total differential power (W) in the unit period of time.

A product of the calculated upper limit of the total differential power (W) and a time equivalent to the unit period of time can be calculated as the upper limit of the total differential power amount (Wh) in the unit period of time.

Even when the content of the instruction to suppress power generation is different for each power generation device 60, like the instruction to suppress power generation illustrated in FIG. 7, the upper limit of the total difference power (W) and the upper limit of the total differential power amount (Wh) in each unit period of time can be calculated similarly.

When the upper limit of the total differential power (W) and the upper limit of the total differential power amount (Wh) in each unit period of time are calculated, like the example illustrated in FIG. 11, it is preferable to ensure the energy storage devices 30 equivalent to outputs equal to or larger than the largest total difference power: 2100 (W) from 13:30 to 14:00. It is preferable to ensure the energy storage devices 30 equivalent to a capacity equal to or larger than 3150 (Wh) obtained by adding up the upper limits of the total differential power amounts in the unit periods of time.

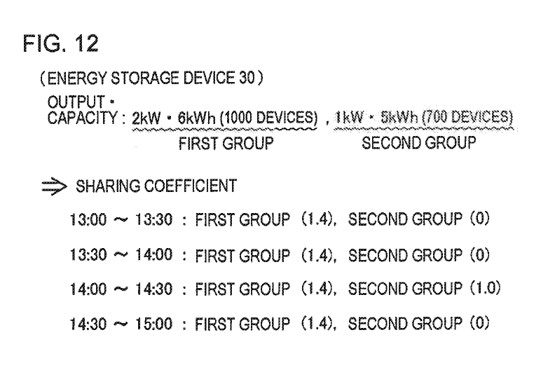

Here, as illustrated in FIG. 12, it is assumed that 1000 energy storage devices 30 (a first group) in which a usable output upper limit is 2 kW and a usable capacity upper limit is 6 kWh and 700 energy storage devices 30 (a second group) in which a usable output upper limit is 1 kW and a usable capacity upper limit is 5 kWh are determined (ensured).

The maximum output sum is 2700 kW and is larger than the upper limit of the total differential power (W) in all the unit periods of time illustrated in FIG. 11. The capacity sum is 9500 kWh and is larger than 3150 (Wh), which is obtained by adding up upper limits of the total differential power amounts in all the unit periods of time illustrated in FIG. 11. That is, the energy storage devices 30 sufficient for the absorbing process are ensured.

In S12, the sharing coefficient of each of the plurality of energy storage devices 30 is determined. Herein, it is assumed that the energy storage devices 30 are divided into the first and second groups and the sharing coefficient is determined for each group.

For example, in the unit period of time from 13:00 to 13:30, the unit period of time from 13:30 to 14:00, and the unit period of time from 14:30 to 15:00, the sharing coefficients are determined under the following conditions.

(1) “The absorbing process is performed by only the energy storage devices 30 of the first group and the absorbing process is not performed by the energy storage devices 30 of the second group”.

(2) “The sharing ratios of the plurality of energy storage devices 30 of the first group are the same”.

In the case of the assumption, as illustrated in FIG. 12, 1.4 is determined as the sharing coefficient of each of the energy storage devices 30 of the first group and 0 is determined as the sharing coefficient of each of the energy storage devices 30 of the second group.

The sharing coefficient is a product of a “value obtained by expressing the sharing ratio to the total differential power by percentage” and an “upper limit of the total differential power (kW) in each unit period of time”.

In the case of the assumption of (1) and (2), the “value obtained by expressing the sharing ratio to the total differential power by percentage” of each of 1000 supply and demand adjustment control devices 20 of the first group is 0.001 (=0.1%). The sharing coefficient of 1.4 is calculated by multiplying the value by the upper limit (1400 kW) of the total differential power of each unit period of time illustrated in FIG. 11.

Since the “value obtained by expressing the sharing ratio to the total differential power by percentage” of each of the supply and demand adjustment control devices 20 of the second group is 0 (0%), a normalized value is also 0.

In the unit period of time from 14:00 to 14:30, the sharing coefficients are determined under the following conditions.

(1)′ The sharing ratio of the whole first group and the whole second group” is 2:1”.

(2)′ The sharing ratios of the plurality of energy storage devices 30 of the first group are the same”.

(3)′ The sharing ratios of the plurality of energy storage devices 30 of the second group are the same”.

From the assumption of (1)′, the upper limit of the total differential power shared in the whole first group is 1400 kW (=2100 kW×2/3). From the assumption of (2)′, the “value obtained by expressing the sharing ratio to the total differential power by percentage” of each of the 1000 supply and demand adjustment control devices 20 of the first group is 0.001 (=0.1%). The sharing coefficient of 1.4 is calculated by multiplying the value by the calculated sharing upper limit (1400 kW) of the first group.

From the assumption of (1)′, the upper limit of the total differential power shared in the whole second group is 700 kW (=2100 kW×1/3). From the assumption of (3)′, the “value obtained by expressing the sharing ratio to the total differential power by percentage” of each of the 700 supply and demand adjustment control devices 20 of the second group is 1/700 (=about 0.14%). The sharing coefficient of 1.0 is calculated by multiplying the value by the calculated sharing upper limit of 700 kW of the second group.

In S12, the control device 10 may calculate a capacity sharing upper limit of each of the plurality of energy storage devices 30. The output upper limit (W) shared by each energy storage device 30 can be calculated using the sharing coefficient. By multiplying the output upper limit by a time in which the absorbing process is performed, it is possible to calculate the capacity sharing upper limit of each energy storage device 30.

In S13 of FIG. 10, the control device 10 transmits the determined sharing coefficient (see FIG. 12) to each of the plurality of supply and demand adjustment control devices 20.

The control device 10 may transmit the capacity sharing upper limit of each energy storage device 30 to each of the plurality of supply and demand adjustment control devices 20. The supply and demand adjustment control device 20 receiving this information controls the energy storage device 30 such that a vacancy equivalent to the capacity sharing upper limit is ensured by a starting point of the absorbing process.

In S14, the control device 10 notifies the plurality of power generation devices 60 of the suppression period of time specified by the instruction to suppress power generation acquired in S10.

The process described above is performed before the suppression period of time specified by the instruction to suppress power generation, which is acquired in S10.

S15 to S19 to be described below are performed in the suppression period of time. S15 to S19 are repeatedly performed during the suppression period of time.

In S15, each of the plurality of power generation devices 60 repeatedly transmits the actually measured value (the instantaneous value (W)) of the power generation output of the power generation device 60 to the control device 10 at the period T1a. The plurality of power generation devices 60 transmit the actually measured values of the power generation outputs by shifting a timing by a time less than the period T1a so that mutually transmitted data is not congested.

In S16, the control device 10 repeatedly calculates the total differential power at a predetermined period. The total differential power is calculated on the basis of the actually measured values of the power generation outputs of the plurality of power generation devices 60 acquired repeatedly in S15. The total differential power is an amount by which the sum of actually measured values of the power generation outputs of the plurality of power generation devices 60 is larger than the sum of upper limit power generation outputs of the plurality of power generation devices 60. A method of calculating the total differential power has been described above.

The control device 10 subsequently calculates a normalized value obtained by dividing the calculated total differential power by the upper limit of the total difference power (kW) in each unit period of time. The normalized value is a value between 0 and 1.

In S17, the control device 10 repeatedly transmits the differential power information indicating the normalized value of the total differential power calculated in S16 to the plurality of supply and demand adjustment control devices 20 at the period T1b. The control device 10 can simultaneously transmit the differential power information with the same content to the plurality of supply and demand adjustment control devices 20 using a scheme such as multicast. The scheme of performing the simultaneous transmission is not limited to multicast and another scheme such as broadcast in which FM communication or the like can also be used.

In S18, each of the plurality of supply and demand adjustment control devices 20 determines charging power and/or consumption power of each supply and demand adjustment control device 20 in the absorbing process on the basis of the sharing coefficient received in S13 and the differential power information (latest differential power information) received repeatedly in S17. Specifically, the supply and demand adjustment control device 20 determines a product of the normalized sharing coefficient and the normalized value (the differential power information) as the charging power and/or consumption power. The supply and demand adjustment control device 20 determines new charging power and/or consumption power on the basis of the new differential power information whenever the new differential power information is acquired.

When the sharing coefficient is determined for each unit period of time of the suppression period of time, the supply and demand adjustment control device 20 determines the charging power and/or consumption power using the sharing coefficient of the unit period of time including a current time.

In S19, each of the plurality of supply and demand adjustment control devices 20 controls each of the plurality of energy storage devices 30 such that the charging and/or consumption is performed with the latest charging power and/or consumption power determined in S18. The operation control unit 24 performs the charging and/or consumption of power with the determined charging power (W)/consumption power (W) for the period T1b until the new differential power information is received. In other words, the charging power amount (Wh)/consumption power amount (Wh) in the period T1b until the new differential power information is received is the value of charging power (W)/consumption power (W)×T1b.

Herein, the example in which the plurality of energy storage devices 30 are divided into the groups and the sharing coefficient common to each group is determined has been described. However, the sharing coefficient may also be determined individually for each of the plurality of energy storage devices 30 without being divided into the groups. As a scheme for grouping, not only a scheme based on the above-described output and capacity but also a scheme disclosed in Japanese Patent No. 5234234 or Japanese Patent No. 5234235 or a grouping scheme based on characteristics of a secondary battery disclosed in WO2013/031394 can be adopted.

Next, operational effects according to the example embodiment will be described.

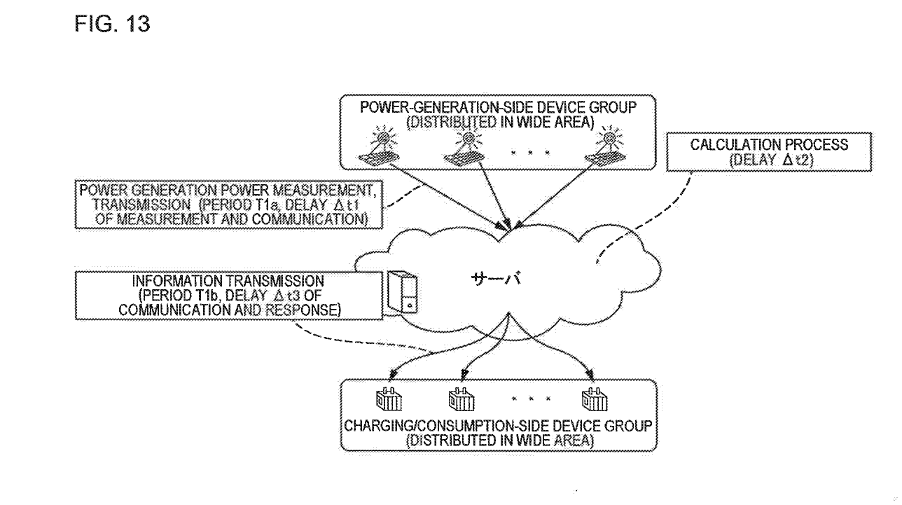

As illustrated in FIG. 13, the supply and demand adjustment system according to the example embodiment includes a power-generation-side device group (the power generation devices 60) distributed in a wide area, the server (the control device 10), and a charging/consumption-side device group (the supply and demand adjustment control devices 20, the energy storage devices 30, and the like) distributed in a wide area.

In this case, as illustrated in the drawing, a delay Δt1 of communication and measurement caused due to measurement of each of a plurality of power-generation-side devices and transmission of data from each device to a server occurs. In addition, a delay Δt2 of a process caused due to a calculation process in the server occurs. Further, a delay Δt3 of communication and response caused due to transmission of data from the server to the plurality of charging/consumption-side devices occurs.

Due to these delays, a time lag increases between a timing at which differential power flows reversely from the power generation devices 60 to the power system and a timing at which the energy storage devices 30 performs the charging and/or the consumption of the differential power.

In the supply and demand adjustment system according to the example embodiment, it is possible to reduce the delay Δt3 of the communication and response. The description thereof will be made below.

In the example embodiment, the control device 10 (the server) determines the sharing coefficient of each of the plurality of energy storage devices 30 earlier than the suppression period of time and transmits the sharing coefficient to each of the plurality of supply and demand adjustment control devices 20 (the charging/consumption-side device group). Then, in the suppression period of time, the control device 10 repeatedly transmits the differential power information to the plurality of supply and demand adjustment control devices 20.

Since the sharing coefficient is transmitted before the suppression period of time, the sharing coefficient is not relevant to the delay Δt3 of the communication and response. Since the content of the differential power information transmitted to the plurality of supply and demand adjustment control devices 20 is the same, the control device 10 can simultaneously transmit the differential power information to the plurality of supply and demand adjustment control devices 20. As a result, the delay Δt3 of the communication and response can be reduced in comparison with the case in which predetermined data is individually transmitted in sequence to the plurality of supply and demand adjustment control devices 20.

In the supply and demand adjustment system according to the example embodiment, it is possible to reduce the delay Δt2 of the process. The description thereof will be made below.

In the supply and demand adjustment system according to the example embodiment, during the suppression period of time, it is necessary to perform “a calculation process of calculating the total differential power on the basis of the actually measured values of the power generation outputs” and “a calculation process of determining the charging power and/or consumption power of each energy storage device 30 on the basis of the calculated total differential power”.

In the example embodiment, the control device 10 performs “the calculation process of calculating the total differential power on the basis of the actually measured values of the power generation outputs” and each of the plurality of supply and demand adjustment control devices 20 performs “the calculation process of determining the charging power and/or consumption power of each energy storage device 30 on the basis of the calculated total differential power”.

That is, “the calculation process of determining the charging power and/or consumption power of each energy storage device 30 on the basis of the calculated total differential power” is shared by the plurality of supply and demand adjustment control devices 20. Then, each of the plurality of supply and demand adjustment control devices 20 determines only the charging power and/or consumption power of the corresponding energy storage device 30. Therefore, the calculation process can be divided to each energy storage device 30 and is performed in parallel.

As a result, it is possible to reduce the delay Δt2 of the process in comparison with the case in which the control device 10 performs both the calculation processes.

According to the example embodiment, the charging power and/or the consumption power of each energy storage device 30 can be determined through a simple calculation process of multiplying the sharing coefficient by a value indicated by the differential power information. Therefore, it is possible to lighten a CPU power or a memory included in each of the plurality of supply and demand adjustment control devices 20 and it is possible to reduce an increase in a delay occurring in the calculation process.

### Second Example Embodiment

A supply and demand adjustment system according to the example embodiment achieves further reduction in the delay Δt2 of the process described with reference to FIG. 13 by characteristics configurations of the control device 10 and the power generation device 60. The configurations of the supply and demand adjustment control device 20 and the energy storage device 30 are the same as those of the first example embodiment. Hereinafter, configurations of the power generation device 60 and the control device 10 will be described.

Each of the plurality of power generation devices 60 acquires the instruction to suppress power generation for each device. For example, the control device 10 may transmit the instruction to suppress power generation acquired from the electricity transmission and distribution service provider system to each power generation device 60. Conversely; the electricity transmission and distribution service provider system may transmit the instruction to suppress power generation to each power generation device 60. In any case, the transmission is performed before the suppression period of time.

Each of the plurality of power generation devices 60 repeatedly calculates the differential power (W) on the basis of the actually measured value (W) of the power generation output and the upper limit power generation output (W) in each unit period of time specified by the instruction to suppress power generation, in the suppression period of time. The differential power is basically an amount by which the actually measured value of the power generation output is larger than the upper limit power generation output. As will be described separately, the differential power below the upper limit power generation output is also calculated.

For example, each of the plurality of power generation devices 60 repeatedly measures a power generation output (instantaneous value (W)) at a predetermined measurement interval (for example, 500 msec) in the suppression period of time. Then, each of the plurality of power generation devices 60 repeatedly calculates the differential power on the basis of the actually measured value. Then, each of the plurality of power generation devices 60 repeatedly transmits the calculated differential power to the control device 10 at the period T1a (for example, a time interval (several seconds) longer than the measurement interval or the same time interval as the measurement interval).

When the period T1a is a time interval longer than the measurement interval, the power generation device 60 may set a representative value (for example, an average value, a maximum value, a minimum value, a mode, or a median value) of the plurality of measured values obtained during the period T1a as the differential power transmitted to the control device 10.

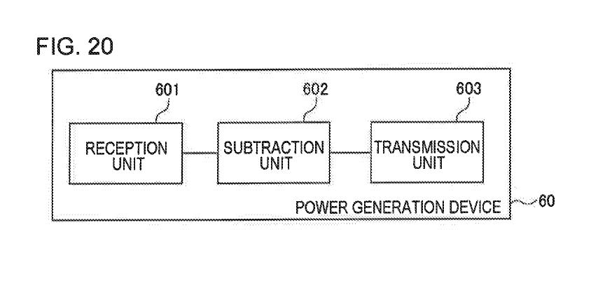

FIG. 20 is an exemplary functional block diagram illustrating the power generation device 60. A reception unit 601 receives the instruction to suppress power generation. A subtraction unit 602 repeatedly calculates the differential power by subtracting the upper limit power generation output from an actually measured value of the power generation. The upper limit power generation output is specified on the basis of the instruction to suppress power generation. A transmission unit 603 repeatedly transmits the differential power calculated by the subtraction unit 602 to the control device 10.

Although not illustrated, the power generation device 60 can include a power generation element and an output control device. The power generation element is a photovoltaic battery panel or the like and generates power using natural energy. The output control device includes a power conditioner and a power generation control unit. The power conditioner adjusts power to be supplied from the power generation element to the power system. The power generation control unit controls the power conditioner, as necessary, and suppresses power supplied from the power generation element to the power system to a predetermined value or less. The output control device may include the reception unit 601, the subtraction unit 602, and the transmission unit 603. Herein, the example in which the power generation device 60 includes the output control device has been described. The power generation device 60 including the power generation element and the output control device may be divided logically and/or physically.

An example of the functional block diagram of the control device 10 is illustrated in FIG. 4, as in the first example embodiment. As illustrated in the drawing, the control device 10 includes the instruction acquisition unit 11, the difference calculation unit 12, the sharing coefficient determination unit 13, the difference notification unit 14, and the sharing coefficient notification unit 15. The configurations of the instruction acquisition unit 11, the sharing coefficient determination unit 13, the difference notification unit 14, and the sharing coefficient notification unit 15 are the same as the configurations of the first example embodiment.

The difference calculation unit 12 receives the power generation relevant information indicating each differential power from each of the plurality of power generation devices 60. Each differential power is an amount by which the actually measured value of the power generation output of each power generation device 60 is larger than the upper limit power generation output of each power generation device 60. When the actually measured value of the power generation output of each power generation device 60 is a value smaller than the upper limit power generation output of each power generation device 60, the difference between the actually measured value and the upper limit power generation output is calculated as a negative value and is set as a negative difference.

Then, the difference calculation unit 12 calculates the total differential power by adding up pieces of the differential power of the plurality of power generation devices 60 received from the power generation device 60.

According to the above-described example embodiment, it is possible to realize the same operational effects as those of the first example embodiment. According to the example embodiment, it is possible to reduce the delay Δt2 of the process described with reference to FIG. 13.

When the total differential power is calculated, it is necessary to perform a “process of calculating the differential power of each power generation device 60” and a “process of adding up the pieces of differential power of power generation devices 60”.

In the example embodiment, each of the plurality of power generation devices 60 performs the “process of calculating the differential power of each power generation device 60” and the control device 10 performs the “process of adding up pieces of the differential power of power generation devices 60”. That is, the “process of calculating the differential power of each power generation device 60” is shared by the plurality of power generation devices 60.

Therefore, it is possible to reduce the delay Δt2 of the process in comparison with the case in which the control device 10 performs both the calculation processes.

Herein, the example in which the power generation device 60 including the power generation element such as a photovoltaic battery panel includes the reception unit 601, the subtraction unit 602, and the transmission unit 603 has been described. Another device logically separated from the power generation device 60 may include the reception unit 601, the subtraction unit 602, and the transmission unit 603. The assumption is the same in other example embodiments.

### Third Example Embodiment

In the supply and demand adjustment system according to the example embodiment, the control device 10 has a function of predicting total differential power for a subsequent period on the basis of past total differential power and transmitting the predicted total differential power to the plurality of supply and demand adjustment control devices 20. The configurations of the supply and demand adjustment control device 20, the energy storage device 30, and the power generation device 60 are the same as those of the first and second example embodiments.

An exemplary functional block diagram of the control device 10 is illustrated in FIG. 4 as in the first and second example embodiments. As illustrated in the drawing, the control device 10 includes the instruction acquisition unit 11, the difference calculation unit 12, the sharing coefficient determination unit 13, the difference notification unit 14, and the sharing coefficient notification unit 15. The configurations of the instruction acquisition unit 11, the sharing coefficient determination unit 13, and the sharing coefficient notification unit 15 are the same as the configurations of the first and second example embodiments.

The difference calculation unit 12 calculates a predicted value of total differential power of a subsequent period on the basis of newly calculated total differential power and previously calculated total differential power. The difference calculation unit 12 can adopt every prediction method. The total differential power of the subsequent period is total differential power transmitted to the plurality of supply and demand adjustment control devices 20 after, for example, the period T1b.

For example, a prediction model may be generated by performing machine learning using a plurality of pieces of training data in which certain total differential power is set as a target variable and chronological data in which pieces of total differential power of immediately previous N times (where N is an integer equal to or greater than 1) are arranged in calculation order is set as a description variable. Then, a predicted value may be obtained by inputting chronological data in which pieces of total differential power of N times including newly calculated total differential power are arranged in calculation order to the prediction model.

In addition, a linear expression (prediction expression) may be calculated in a graph in which the horizontal axis represents a time and the vertical axis represents total differential power, using total differential power newly calculated at t1 and total differential power calculated immediately previously at t0. Then, the predicted value may be obtained by inputting a time t2 of a subsequent period to the linear expression.

The difference notification unit 14 transmits a predicted value of total differential power of a subsequent period calculated on the basis of the total differential power calculated by the difference calculation unit 12 as differential power information to the plurality of supply and demand adjustment control devices 20 instead of the total differential power calculated by the difference calculation unit 12.

According to the above-described example embodiment, it is possible to realize the same operational effects as those of the first and second example embodiments. According to the example embodiment, the control device 10 can estimate the total differential power of the subsequent period and notify the supply and demand adjustment control device 20 of the total differential power. In particular, since the differential power is estimated with regard to a total value of the plurality of power generation devices 60, an averaging effect can be expected and an abrupt output fluctuation can be alleviated. As a result, it is possible to estimate the more accurate differential power. As described above, it is possible to solve the problem of the time lag between a timing at which differential power flows reversely from the power generation devices 60 to the power system and a timing at which the energy storage devices 30 performs the charging and/or the consumption of the differential power, and thus it is possible to sufficiently decrease a fluctuation in a supply and demand balance caused by the time lag.

When the configurations of the first and second example embodiments can be provided, as described in these example embodiments, it is possible to reduce the delay Δt2 of the process and the delay Δt3 of the communication and response. Therefore, it is possible to reduce a period from measurement of the output of the power generation device 60 to the determination of the charging power and/or consumption power of the energy storage device 30 based on the measured value. As a result, it is easy to predict the total differential power of the subsequent period, and thus it is possible to improve prediction precision.

Incidentally, the second example embodiment can be modified on the basis of the example embodiment. That is, the output control device (the subtraction unit 602) described in the second example embodiment may calculate a predicted value of differential power of a subsequent period on the basis of newly calculated differential power and previously calculated differential power. The output control device (the subtraction unit 602) may calculate a difference between the calculated predicted value and a target power generation output. Then, the output control device (the transmission unit 603) may repeatedly transmit the difference calculated in this way (the difference between the predicted value and the target power generation output) to the control device 10. The output control device may adopt the same prediction method as the above-described difference calculation unit 12.

### Fourth Example Embodiment

The control device 10 of the supply and demand adjustment system according to the example embodiment has a function of redetermining the sharing coefficient of each of the plurality of energy storage devices 30 in the suppression period of time and transmitting the sharing coefficient to each supply and demand adjustment control device 20. The configurations of the energy storage device 30 and the power generation device 60 are the same as those of the first to third example embodiments.

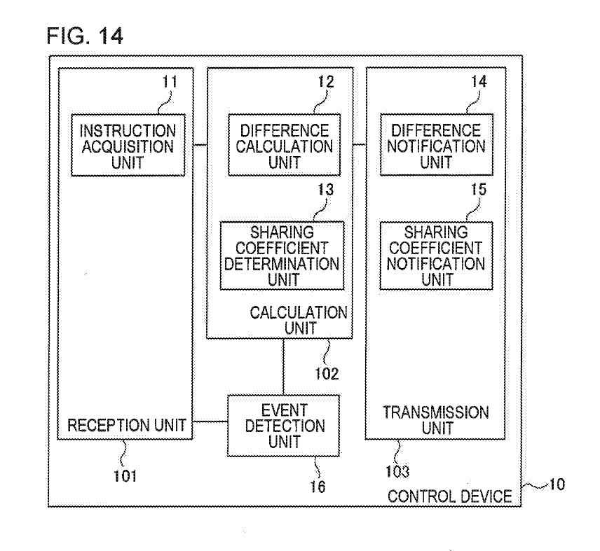

An exemplary functional block diagram of the control device 10 is illustrated in FIG. 14 example embodiments. As illustrated in the drawing, the control device 10 includes the instruction acquisition unit 11, the difference calculation unit 12, the sharing coefficient determination unit 13, the difference notification unit 14, the sharing coefficient notification unit 15, and an event detection unit 16. The configurations of the instruction acquisition unit 11, the difference calculation unit 12, and the difference notification unit 14 are the same as the configurations of the first to third example embodiments.

The event detection unit 16 monitors a state of a communication path reaching from the control device 10 to the supply and demand adjustment control device 20 or a state (a full charging state or a depletion state of a secondary battery, a value of SOC, or the like) of the energy storage device 30 and detects occurrence of an event changing the sharing coefficient in the suppression period of time. As the event, an “event indicating that some of the energy storage devices 30 which are performing an absorbing process may not perform the absorbing process” is considered due to a communication failure, considerable delay of communication, an abnormal increase in temperature of the energy storage devices 30, overcurrent occurrence, occurrence of voltage abnormality, or runout of a charging ability since the energy storage device 30 have been used for another purpose or the like.

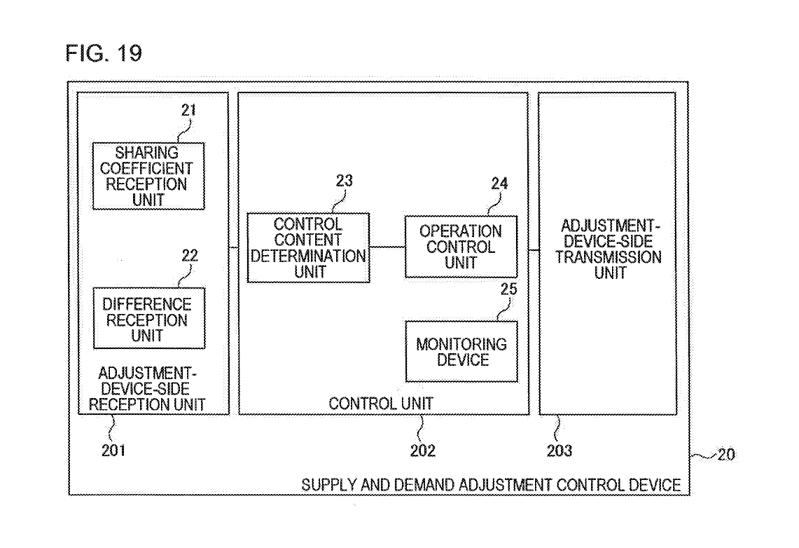

For example, the reception unit 101 may also receive an input of an event occurrence signal from a monitoring device monitoring an operation of the energy storage device 30 which is performing an absorbing process, an input of such information from an operator of the control device 10, or the like. Then, the event detection unit 16 may detect occurrence of an event changing the sharing coefficient on the basis of the signal or information. For example, as illustrated in FIG. 19, the supply and demand adjustment control device 20 may include the monitoring device 25.

The sharing coefficient determination unit 13 redetermines the sharing coefficient of each of the energy storage devices 30 according to occurrence detection of an event.

For example, when an “event indicating that some of the energy storage devices 30 which are performing an absorbing process may not perform the absorbing process” occurs, the sharing coefficient determination unit 13 determines the sharing coefficients of the absorbing process again for only the energy storage devices 30 that can perform the sharing process. The determination method is the same as that described in the first example embodiment.

The sharing coefficient notification unit 15 transmits the redetermined sharing coefficient of each of the plurality of energy storage devices 30 to each of the plurality of supply and demand adjustment control devices 20 according to the redetermination of the sharing coefficient by the sharing coefficient determination unit 13.

An exemplary functional block diagram of the supply and demand adjustment control device 20 according to the example embodiment is illustrated in FIG. 9 or 19. As illustrated in FIG. 9, the supply and demand adjustment control device 20 includes the sharing coefficient reception unit 21, the difference reception unit 22, the control content determination unit 23, and the operation control unit 24. As illustrated in FIG. 19, the supply and demand adjustment control device 20 may further include the monitoring device 25 and an adjustment-device-side transmission unit 203. The configurations of the difference reception unit 22 and the operation control unit 24 are the same as those of the first to third example embodiments.

The sharing coefficient reception unit 21 receives the redetermined sharing coefficient whenever an event changing the sharing coefficient occurs.

The control content determination unit 23 determines charging power and/or consumption power of the energy storage device 30 on the basis of the latest sharing coefficient and latest differential power information. That is, when the sharing coefficient reception unit 21 receives the redetermined sharing coefficient, the control content determination unit 23 subsequently determines the charging power and/or consumption power of the energy storage device 30 on the basis of the redetermined sharing coefficient.

Here, a specific example will be described. For example, as described in the first example embodiment, the control device 10 is assumed to acquire the instruction to suppress power generation, as illustrated in FIG. 8, for 10 power generation devices 60 with a rated output of 500 kW and 5 power generation devices 60 with a rated output of 400 kW.

Then, as illustrated in FIG. 12, it is assumed that 1000 energy storage devices 30 (a first group) in which a usable output upper limit is 2 kW and a usable capacity upper limit is 6 kWh and 700 energy storage devices 30 (a second group) in which a usable output upper limit is 1 kW and a usable capacity upper limit is 5 kWh are determined (ensured) and the sharing coefficients as illustrated in the drawing are determined for the energy storage devices 30 of each group.

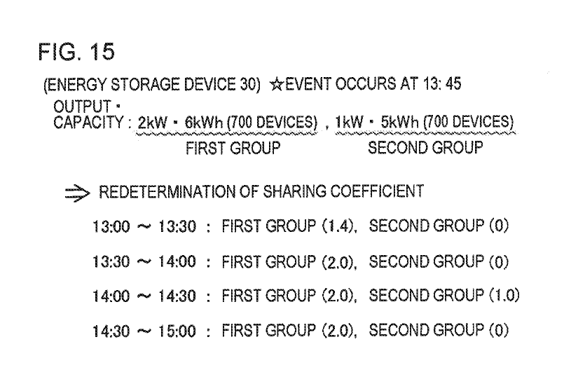

On the assumption, as illustrated in FIG. 15, a trouble occurs in 300 energy storage devices 30 of the first group at 13:45 of the suppression period of time. Thereafter, the absorbing process is performed by 700 energy storage devices 30 of the first group and 700 energy storage devices 30 of the second group.

The sharing coefficient determination unit 13 determines the subsequent sharing coefficients again in each unit period of time in response to the trouble. That is, in the case of this example, the sharing coefficient determination unit 13 determines the sharing coefficients again at each time from 13:30 to 14:00, from 14:00 to 14:30, and from 14:30 to 15:00.

For example, in the unit period of time from 13:30 to 14:00 and the unit period of time from 14:30 to 15:00, the sharing coefficients are determined under the following conditions.

(1) “The absorbing process is performed by only the energy storage devices 30 of the first group and the absorbing process is not performed by the energy storage devices 30 of the second group”.

(2) “The sharing ratios of the plurality of energy storage devices 30 of the first group are the same”.

In the case of the assumption of (1) and (2), the “value obtained by expressing the sharing ratio to the total differential power by percentage” of each of 700 supply and demand adjustment control devices 20 of the first group is 1/700 (=about 0.14%). The sharing coefficient of 2.0 is calculated by multiplying the value by the upper limit (1400 kW) of the total differential power of each unit period of time illustrated in FIG. 11. That is, when the upper limit of the total differential power is changed, the sharing coefficient of each battery is changed.

Since the “value obtained by expressing the sharing ratio to the total differential power by percentage” of each of the supply and demand adjustment control devices 20 of the second group is 0 (0%), a normalized value is also 0.

In the unit period of time from 14:00 to 14:30, the sharing coefficients are determined under the following conditions.

(1)′ “The sharing ratio of the whole first group and the whole second group is 2:1”.

(2)′ “The sharing ratios of the plurality of energy storage devices 30 of the first group are the same”.

(3)′ “The sharing ratios of the plurality of energy storage devices 30 of the second group are the same”.

From the assumption of (1)′, the upper limit of the total differential power shared in the whole first group is 1400 kW (=2100 kW (see FIG. 11)×2/3). From the assumption of (2)′, the “value obtained by expressing the sharing ratio to the total differential power by percentage” of each of the 700 supply and demand adjustment control devices 20 of the first group is 1/700 (=about 0.14%). The sharing coefficient of 2.0 is calculated by multiplying the value by the calculated sharing upper limit (1400 kW) of the first group.

From the assumption of (1)′, the upper limit of the total differential power shared in the whole second group is 700 kW (=2100 kW (see FIG. 11)×1/3). From the assumption of (3)′, the “value obtained by expressing the sharing ratio to the total differential power by percentage” of each of the 700 supply and demand adjustment control devices 20 of the second group is 1/700 (=about 0.14%). The sharing coefficient of 1.0 is calculated by multiplying the value by the calculated sharing upper limit of 700 kW of the second group.

The difference notification unit 14 transmits the sharing coefficient redetermined in this way to each of the plurality of supply and demand adjustment control devices 20.

The monitoring device 25 acquires (detects or measures) state information indicating states of the energy storage devices 30 via the adjustment-device-side reception unit 201. Then, the monitoring device 25 repeatedly transmits the state information to the control device 10 via the adjustment-device-side transmission unit 203. The state information is, for example, SOC, a vacant capacity (Wh), a charging amount (Wh), a voltage, a current, temperature, a storage energy amount, or error information. The adjustment-device-side transmission unit 203 transmits predetermined information to an external device.

According to the above-described example embodiment, it is possible to realize the same operational effects as those of the first to third example embodiments. According to the example embodiment, when a predetermined event occurs, the sharing coefficients can be changed immediately.

For example, when an “event indicating that some of the energy storage devices 30 which are performing an absorbing process may not perform the absorbing process” occurs, the plurality of energy storage devices 30 may not perform charging and/or consumption of the total differential power in an existing setting state. When this state is left as it is, oversupply occurs and a supply and demand balance of the power system collapses.

In this example embodiment, by changing the sharing coefficients immediately in response to occurrence of the above-described event, it is possible to change sharing of the charging and/or consumption by each energy storage device 30. As a result, even in a situation after the event occurs, it is possible to appropriately charge and/or consume the total differential power.

For a timing at which the sharing coefficients are changed, the control device 10 can individually deliver the sharing coefficients to the supply and demand adjustment control devices 20 periodically (the same sharing coefficients are repeatedly transmitted when no event occurs), as will be described in a fifth example embodiment, in addition to the method of changing the sharing coefficients unperiodically when an event occurs, as described above. Even when an event occurs, the sharing coefficients may be changed using the periodic communication.

### Fifth Example Embodiment

The control device 10 of the supply and demand adjustment system according to the example embodiment repeatedly acquires state information indicating state of each of the plurality of energy storage devices 30 in the suppression period of time and repeatedly determines the sharing coefficient of each of the plurality of energy storage devices 30 on the basis of the state information. Then, the control device 10 repeatedly transmits the repeatedly determined sharing coefficient to each supply and demand adjustment control device 20.

The configurations of the energy storage device 30, the power generation device 60, and the like are the same as those of the first to fourth example embodiments.

An exemplary functional block diagram of the control device 10 is illustrated in FIG. 4 or 14. As illustrated in the drawing, the control device 10 includes the instruction acquisition unit 11, the difference calculation unit 12, the sharing coefficient determination unit 13, the difference notification unit 14, and the sharing coefficient notification unit 15. The configurations of the instruction acquisition unit 11, the difference calculation unit 12, and the difference notification unit 14 are the same as the configurations of the first to fourth example embodiments.

The sharing coefficient determination unit 13 repeatedly determines the sharing coefficient of each of the plurality of energy storage devices 30 in the suppression period of time (while the energy storage devices 30 are performing the absorbing process).

The sharing coefficient determination unit 13 repeatedly acquires state information indicating a state of each of the plurality of energy storage devices 30 from each of the plurality of supply and demand adjustment control devices 20. The state information is, for example, a state of charge (SOC), a vacant capacity (Wh), a charging amount (Wh), a voltage, a current, temperature, a storage energy amount, or error information. The state information may include not only state information such as SOC in the supply and demand adjustment control device 20 but also a status of a communication path (communication disconnection or the like) for each supply and demand adjustment control device 20 and the control device 10 or breakdown or the like of the supply and demand adjustment control device 20.

In the present specification, “reception”, “acquisition”, and “ascertainment” includes at least one of (active acquisition) that an apparatus itself acquires data or information such as a state or data stored in another apparatus or a storage medium, for example, that the apparatus itself receives data or information by making a request or a query to another apparatus, or reads out data or information by making an access to another apparatus or a storage medium, and (passive acquisition) that data or information output from another device is input to the apparatus, for example, that data or information distributed (transmitted, push notified, or the like) are received. Selection and acquisition from received data or information or selection and reception of delivered data or information can also be included.

The sharing coefficient determination unit 13 redetermines the sharing coefficient of each of the plurality of energy storage devices 30 on the basis of state information (for example, SOC, a vacant capacity (Wh), or a charging amount (Wh)) indicating a state of each of the plurality of energy storage devices 30. That is, the sharing coefficient determination unit 13 redetermines the sharing coefficient (the sharing ratio) appropriate to each energy storage device 30 according to the latest state of each of the plurality of energy storage devices 30. Since a sufficiently long calculation time is necessary in the process of redetermining the sharing coefficient, a period at which the sharing coefficient is transmitted is longer than a period (the period T1b described in the first to fourth example embodiments) at which the differential power information is transmitted.

For example, the sharing coefficient determination unit 13 may determine a larger sharing ratio for the energy storage device 30 having lower SOC. In addition, the sharing coefficient determination unit 13 may determine a larger sharing ratio for the energy storage device 30 having a larger vacant capacity. When SOC or the charging amount (Wh) is received, on the basis of the information and the rated capacity of each energy storage device 30 registered in advance, the sharing coefficient determination unit 13 may calculate the vacant capacity (Wh) of each energy storage device 30.

The sharing coefficient notification unit 15 repeatedly transmits the sharing coefficient of each of the plurality of energy storage devices 30 to the plurality of supply and demand adjustment control devices 20 in the suppression period of time (while the energy storage devices 30 are performing the absorbing process). A period (for example, from several minutes to tens of minutes) at which the sharing coefficient is transmitted is longer than a period (the period T1b described in the first to fourth example embodiments: for example, several seconds) at which the difference notification unit 14 transmits the differential power information.

An exemplary functional block diagram of the supply and demand adjustment control device 20 is illustrated in FIG. 19. As illustrated in the drawing, the supply and demand adjustment control device 20 includes the sharing coefficient reception unit 21, the difference reception unit 22, the control content determination unit 23, the operation control unit 24, and the monitoring device 25. The configurations of the difference reception unit 22 and the operation control unit 24 are the same as those of the first to fourth example embodiments.

The sharing coefficient reception unit 21 repeatedly receives the sharing coefficient of the corresponding energy storage device 30 in the suppression period of time (while the energy storage device 30 is performing the absorbing process). A period at which the sharing coefficient is received is longer than a period (the period T1b described in the first to fourth example embodiments) at which the difference reception unit 22 receives the differential power information.

The control content determination unit 23 determines control content on the basis of the latest sharing coefficient received by the sharing coefficient reception unit 21 and the latest differential power information received by the difference reception unit 22. For example, the control content determination unit 23 may determine the charging power and/or consumption power of the energy storage device 30 in accordance with the same scheme as that of the first to fourth example embodiments.

The monitoring device 25 acquires the state information indicating the state of the energy storage device 30 and repeatedly transmits the state information to the control device 10. The state information is, for example, SOC, a vacant capacity (Wh), a charging amount (Wh), a voltage, a current, temperature, a storage energy amount, or error information.

According to the above-described example embodiment, it is possible to realize the operational effects as those of the first to fourth example embodiments. According to the example embodiment, it is possible to determine the sharing ratio (the sharing coefficient) of each energy storage device 30 according to the latest state of each energy storage device 30 that performs the absorbing process.

For example, even when a use condition determined by a manager of the energy storage device 30 allows the use of up to 5 kWh, a situation in which the capacity is not ensured in the energy storage device 30 can occur because the manager forgets discharging or the like. When the manager forgets that the energy storage device 30 is performing the absorbing process and charging and discharging is controlled by operation on the side of the energy storage device 30, a situation in which the capacity is not usable can occur.

According to the example embodiment, on the basis of not only the use condition determined by the manager but also a latest state (for example, SOC) of each energy storage device 30, the sharing coefficient can be repeatedly determined in the suppression period of time. Therefore, even when the above-described unexpected situation occurs, the sharing coefficient (the sharing ratio) can be determined again according to the situation. As a result, even when the above-described unexpected situation occurs, it is possible to appropriately absorb the total differential power.

In the example embodiment, a period at which the state information indicating the state of the energy storage device 30 is acquired and the sharing coefficient is determined and transmitted can be set to be greater than a period at which the differential power information is transmitted. Since the state of the energy storage device 30 is rarely changed considerably in a short time, the relatively long period can be set. By suppressing a transmission or reception frequency of information for detecting the state of the energy storage device 30 or a transmission or reception frequency of the sharing coefficient, it is possible to reduce a processing load of the system or a congestion state of the communication path.

In the case of the example embodiment, the adjustment-device-side reception unit 201 of the supply and demand adjustment control device 20 receives the differential power information at, for example, a period Tm and receives the sharing coefficient at a period Tn. Herein, when A is the differential power information and B is the sharing coefficient, for example, the adjustment-device-side reception unit 201 receives the differential power information A at the period Tm (an interval of several seconds) and receives the differential power information A and the sharing coefficient B together at a timing at which a predetermined number of times comes, which is when the period Tn passes (A, A, . . . , A, A+B, A, . . . A+B). Thereafter, similarly to the above, the adjustment-device-side reception unit 201 may repeatedly perform communication in which the differential power information A is continuously received at an interval of the period Tm and the differential power information A and the sharing coefficient B are received together at the timing at which the period Tn passes.

### Sixth Example Embodiment

When the sum (W) of the actually measured values of the power generation of the plurality of power generation devices 60 is larger than the sum (W) of the target values (the target power generation outputs) of the power generation of the plurality of power generation devices 60, the supply and demand adjustment system according to the example embodiment absorbs the excess amount with the plurality of energy storage devices 30. That is, the excess amount is charged or consumed.

When the sum (W) of the actually measured values of the power generation of the plurality of power generation devices 60 is smaller than the sum (W) of the target values of the power generation of the plurality of power generation devices 60, the supply and demand adjustment system according to the example embodiment absorbs the amount below the sum of the target values with the plurality of energy storage devices 30. That is, the amount below the sum of the target values is discharged, or when charging is performed irrespective of the control, the charging and/or consumption of the amount below the sum of the target values is suppressed (reduced).

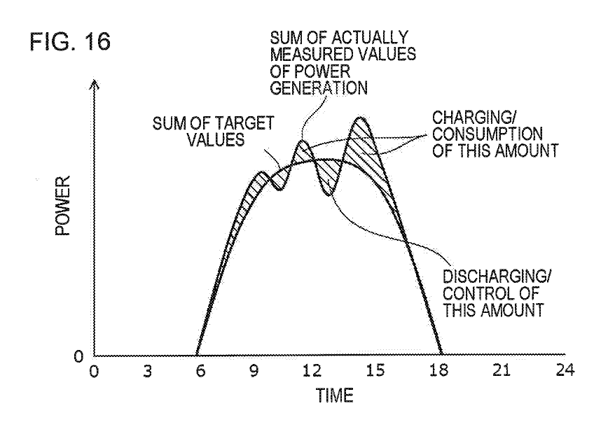

For example, as illustrated in FIG. 16, it is assumed that the sum (W) of the target values of the plurality of power generation devices 60 is determined as illustrated in the drawing. Then, the sum (W) of the actually measured values of the power generation of the plurality of power generation devices 60 is assumed to be in a situation illustrated in the drawing. In this case, the supply and demand adjustment system according to the example embodiment absorbs power equivalent to portions indicated by diagonal lines in the drawing. Specifically, when the sum (W) of the actually measured values of power generation is larger than the sum (W) of the target values, the excess amount is charged or consumed. When the sum (W) of the actually measured values of power generation is smaller than the sum (W) of the target values, the amount below the sum of the target values is discharged. When the charging and/or consumption is performed irrespective of the control, the charging and/or consumption of the amount below the sum of the target values is suppressed (reduced).

An overall picture of the supply and demand adjustment system according to the example embodiment is illustrated in FIG. 2, as in the first to fifth example embodiments.

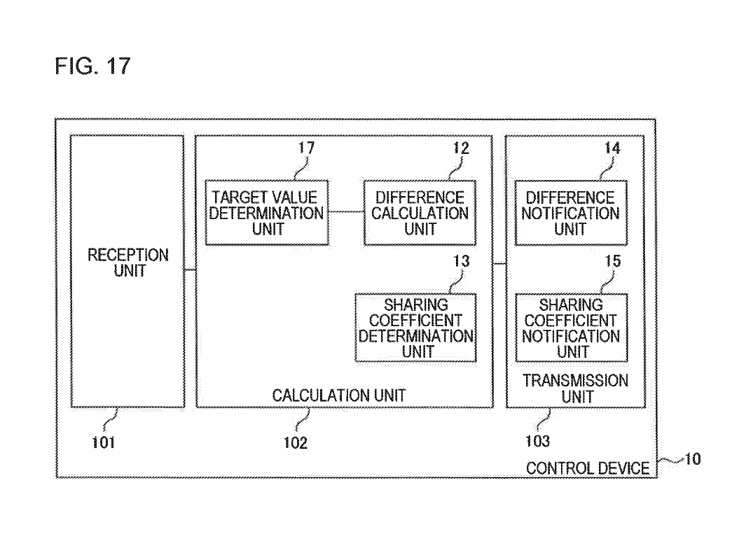

FIG. 17 is an exemplary functional block diagram illustrating the control device 10 according to the example embodiment. As illustrated in the drawing, the control device 10 includes the reception unit 101, the calculation unit 102, and the transmission unit 103. The calculation unit 102 includes a target value determination unit 17, the difference calculation unit 12, and the sharing coefficient determination unit 13. The transmission unit 103 includes the difference notification unit 14 and the sharing coefficient notification unit 15. The difference notification unit 14 and the sharing coefficient notification unit 15 can perform communication via the same communication unit.

The configurations of the sharing coefficient determination unit 13, the difference notification unit 14, and the sharing coefficient notification unit 15 are the same as those of the first to fifth example embodiments.

The target value determination unit 17 determines a target value of the power generation output of each of the plurality of power generation devices 60 or the sum of the target values of the power generation outputs of the plurality of power generation devices 60.

The target value determination unit 17 can repeatedly determine the target value or the sum of the target values dynamically during the absorbing process. The target value determination unit 17 may determine the target value or the sum of the target values on the basis of power generation situations of the plurality of power generation devices 60.

For example, the target value determination unit 17 may determine a moving average (for example, a moving average for 30 minutes) of the actually measured values (W) of the power generation outputs of the plurality of power generation devices 60 as the target value (W) of the power generation output of each power generation device 60. That is, the target value (W) of the power generation output at a certain timing may be an average value of the actually measured values (W) for latest 30 minutes. Then, the target value determination unit 17 may determine the sum (W) of the target values of the power generation outputs of the plurality of power generation devices 60 by adding up the target values (W) of the power generation outputs of the power generation devices 60.

In addition, the target value determination unit 17 may determine the moving average (for example, a moving average for 30 minutes) of the sums of the actually measured values (W) of the power generation outputs of the plurality of power generation devices 60 as the sum (W) of the target values of the power generation outputs of the plurality of power generation devices 60.

In addition, the target value determination unit 17 may determine a target value of the power generation output of each of the plurality of power generation devices 60 on the basis of a predetermined rate of change to the actually measured value (W) of the power generation output of each of the plurality of power generation devices 60. That is, a value changed by the rate of change from the actually measured value may be the target value. The predetermined rate of change may be determined in advance. Then, the target value determination unit 17 may determine the sum (W) of the target values of the power generation outputs of the plurality of power generation devices 60 by adding up the target values (W) of the power generation outputs of the power generation devices 60.

Similarly, the target value determination unit 17 may determine the sum (W) of the target values of the power generation outputs of the plurality of power generation devices 60 on the basis of the predetermined rate of change to the sum of the actually measured values (W) of the power generation outputs of the plurality of power generation devices 60.

The target value determination unit 17 may determine the target value or the sum of the target values as a target of a fixed value before the absorbing process. For example, a case in which power generation prediction is performed in advance and the predicted value is set as a target, a case in which an ideal power generation amount is set as a target for each period of time in consideration of stability of the power system, or a case in which a target is set so that an output change speed (a ramp rate) per unit period of time is equal to or less than a certain value is considered. In this case, the fixed value may be determined as one value such as oo kW or may be determined to have a given width such as oo kW or more and xx kW or less.

The difference calculation unit 12 repeatedly calculates a difference (total differential power) between the sum of the actually measured values of the plurality of power generation devices 60 and the sum of the target values of the plurality of power generation devices 60.

For example, as described in the first example embodiment, the difference calculation unit 12 may acquire the actually measured value from each of the plurality of power generation devices 60. Then, the difference calculation unit 12 may calculate the sum of the actually measured values of the plurality of power generation devices 60 by adding up the actually measured values and calculate the total differential power using the value of the sum.

In addition, as described in the second example embodiment, the difference calculation unit 12 may receive a difference (individual differential power) between the target value and the actually measured value from each of the plurality of power generation devices 60. Then, the difference calculation unit 12 may calculate the total differential power by adding up pieces of the individual differential power received from power generation devices 60.

In this case, each of the plurality of power generation devices 60 repeatedly calculates the individual differential power on the basis of the target value of the self-device and the actually measured value of the self-device and repeatedly transmits the individual differential power to the control device 10. The power generation device 60 may receive the target value of each power generation device 60 determined by the target value determination unit 17 from the control device 10 or the self-device may determine the target value of the self-device as in the target value determination unit 17. The target value which is a fixed value may be transmitted in advance to each of the plurality of power generation devices 60. The other remaining configuration of the power generation device 60 is the same as that of the first to fifth example embodiments.

The difference calculation unit 12 calculates the total differential power by which the sum of the actually values is larger than the sum of the target values and the total differential power by which the sum of the actually measured values is smaller than the sum of the target values in a distinguishing manner.

When the target value is determined to have a given width such as oo kW or more and xx kW or less, the individual differential power (the total differential power) by which the actually measured value (the sum of the actually measured values) is larger than the target value (the sum of the target values) can be calculated as a difference between the actually measured value (the sum of the actually measured values) and the upper limit of the target value (sum of the upper limits of the target values). Then, the individual differential power (the total differential power) by which the actually measured value (the sum of the actually measured values) is smaller than the target value (the sum of the target values) can be calculated as a difference between the actually measured value (the sum of the actually measured values) and the lower limit of the target value (sum of the lower limits of the target values). In this case, a case in which the actually measured value is within a range of the width of the target value and no difference consequently occurs (a difference of 0) is assumed and difference absorption control is not performed at this time.

The difference notification unit 14 repeatedly transmits differential power information indicating the total differential power calculated by the difference calculation unit 12 to the plurality of supply and demand adjustment control devices 20. In the differential power information, the total differential power by which the sum of the actually measured values is larger than the sum of the target values and the total differential power by which the sum of the actually measured values is smaller than the sum of the target values can be distinguished. For example, the total differential power by which the sum of the actually measured values is larger than the sum of the target values may be indicated by a positive numeral value, and the total differential power by which the sum of the actually measured values is smaller than the sum of the target values may be indicated by a negative numeral value.

The other remaining configurations (the calculation period, the transmission period, and the like) of the difference calculation unit 12 and the difference notification unit 14 are the same as those of the first to fifth example embodiments.

An exemplary functional block diagram of the supply and demand adjustment control device 20 according to the example embodiment is illustrated in FIG. 9. As illustrated in the drawing, the supply and demand adjustment control device 20 includes the sharing coefficient reception unit 21, the difference reception unit 22, the control content determination unit 23, and the operation control unit 24. The configuration of the sharing coefficient reception unit 21 is the same as that of the first to fifth example embodiments.

The difference reception unit 22 repeatedly receives the differential power information indicating the difference (the total differential power) between the sum of the actually measured values of the plurality of power generation devices 60 and the sum of the target values of the plurality of power generation devices 60. The other remaining configuration of the difference reception unit 22 according to the example embodiment is the same as that of the first to fifth example embodiments.

The control content determination unit 23 determines control content of the energy storage device 30 on the basis of the sharing coefficient received by the sharing coefficient reception unit 21 and the differential power information received by the difference reception unit 22.

When the sum of the actually measured values is larger than the sum of the target values, the control content determination unit 23 determines that the charging and/or consumption of the share indicated by the sharing coefficient in the total differential power (the power (W)) indicated by the differential power information is performed.

When the sum of the actually measured values is smaller than the sum of the target values, the control content determination unit 23 determines that the discharging and/or suppression of the share (W) indicated by the sharing coefficient in the total differential power (the power (W)) indicated by the differential power information is performed.

Here, the “suppression” will be described. For example, it is assumed that the energy storage device 30 performs a charging process with M (kW) irrespective of the absorbing process (by control independent from the absorbing process) at the time of the absorbing process. Then, it is assumed that the share is equivalent to discharging of N (kW). In this case, the control content determination unit 23 can suppress N (kW) and determine charging power of the charging of the energy storage device 30 to be M−N (kW) (when M−N is negative, the minus amount is discharged).

Similarly, it is assumed that the energy storage device 30 performs a thermal energy storage process with consumption power M (kW) irrespective of the absorbing process at the time of the absorbing process (by control independent from the absorbing process) at the time of the absorbing process. Then, it is assumed that the share is equivalent to the discharging of N (kW). In this case, the control content determination unit 23 can suppress N (kW) and determine consumption power of the thermal energy storage process of the energy storage device 30 to be M−N (kW).

The operation control unit 24 controls the energy storage device 30 with the control content determined by the control content determination unit 23.

That is, when the sum of the actually measured values is larger than the sum of the target values, the operation control unit 24 controls the energy storage device 30 such that the share indicated by the sharing coefficient in the total differential power is charged and/or consumed.

When the sum of the actually measured values is smaller than the sum of the target values, the operation control unit 24 controls the energy storage device 30 such that the share indicated by the sharing coefficient in the total differential power is discharged and suppression of charging equivalent to the share and/or suppression of consumption equivalent to the share is performed.

As a modification example of the example embodiment, the sharing coefficient determination unit 13 may calculate (determine) the sharing coefficient corresponding to each of a case (a first case) in which the sum of the power generation outputs (the actually measured values of power generation) of the plurality of power generation devices 60 is larger than the sum of the target values (the target power generation outputs) of the plurality of power generation devices 60 and a case (a second case) in which the sum of the power generation outputs is smaller than the sum of the target values. Then, the sharing coefficient notification unit 15 transmits the sharing coefficients of the two patterns to the plurality of supply and demand adjustment control devices 20.

In this case, the sharing coefficient determination unit 13 may determine the sharing coefficient of each energy storage device 30 on the basis of information (for example, SOC) indicating a state (an energy storage situation or vacant situation) of each energy storage device 30. For the energy storage device 30 having a large vacant capacity, the sharing coefficient of the first case is set to be relatively large and the sharing coefficient of the second case is set to be relatively small. In contrast, for the energy storage device 30 having a small vacant capacity and storing much energy, the sharing coefficient of the first case is set to be relatively small and the sharing coefficient of the second case is set to be relatively large.

In the case of the modification example, when the sum of the actually measured values is larger than the sum of the target values (the first case), the control content determination unit 23 of the supply and demand adjustment control device 20 determines the share indicated by the sharing coefficient corresponding to the first case in the total differential power (the power (W)) indicated by the differential power information so that the charging and/or consumption equivalent thereto is performed.

In the case of the modification example, when the sum of the actually measured values is smaller than the sum of the target values (the second case), the control content determination unit 23 determines the share (W) indicated by the sharing coefficient corresponding to the second case in the total differential power (the power (W)) indicated by the differential power information so that the discharging and/or suppression equivalent thereto is performed.

Here, the example embodiment will be described giving a specific example. For example, it is assumed that the control device 10 performs control from 10:00 to 15:00 such that a difference between a moving average of 10 minutes and all the power generation outputs, a total rated value of 20000 kW (20 thousands kW) of a total 45 devices, including 20 power generation devices 60 with an rated output of 500 kW and 25 power generation devices 60 with a rated output 400 kW, is absorbed.

For the absorbing process, 30000 energy storage devices 30 in which the usable output upper limit is 2 kW and a usable capacity upper limit is 6 kWh are assumed to have been procured. Then, SOC is predicted at the stage of 10:00 for each energy storage device 30, and 15000 devices having the predicted value of SOC in the range of 30% to 70% are ensured as control candidates for the absorption. That is, a usable output upper limit of the energy storage devices is 30000 kW.

In actual control, the control device 10 collects and adds the actually measured values of the power generation of the power generation devices 60 to obtain a total output value and derives a difference a between the moving average value of 10 minutes of the total output and the total output value. Then, a value β normalized by dividing the difference α by the total rated value of 20000 kW is derived. That is, the normalized output β results in a value of −1 to 1 (equivalent to a maximum of ±20000 kW).

Then, for 10000 energy storage devices 30 as candidates, the following determination is made according to the value of the SOC at the stage of 10:00 and the value of the normalized output β.

That is, when β is positive (when the actually measured output is larger than the target: the first case), output control is performed setting the sharing coefficient of the energy storage devices 30 of which SOC is equal to or greater than 30% and less than 50% to 1 and setting the sharing coefficient of the energy storage devices 30 of which SOC is equal to or greater than 50% and less than 70% to 0.8 because charging is necessary.

Conversely, when β is negative (when the actually measured output is smaller than the target: the second case), output control is performed setting the sharing coefficient of the energy storage devices 30 of which SOC is equal to or greater than 50% and less than 70% to 1 and setting the sharing coefficient of the energy storage devices 30 of which SOC is equal to or greater than 30% and less than 50% to 0.8.

In this case, each energy storage device 30 performs charging or discharging with an output of the rated output×the sharing coefficient×β[kW] of each energy storage device 30.

According to the above-described example embodiment, it is possible to realize the same operational effects as those of the first to fifth example embodiments.

According to the example embodiment, when the sum of the actually measured values of the plurality of power generation devices 60 is larger than the target value and is also smaller than the target value, the difference can be absorbed by the plurality of energy storage devices 30. Therefore, when a supply and demand balance of the power system is oversupply or undersupply, the supply and demand balance of the power system can be kept by the plurality of energy storage devices 30.

Finally, an example of a hardware configuration of each device (the control device, the supply and demand adjustment control device, the energy storage device, and the power generation device) described in the first to sixth example embodiments will be described. Each unit included in the device according to the example embodiment is configured in any combination of software and hardware of any computer, focusing on a central processing unit (CPU), a memory, a program loaded to the memory, a memory unit such as a hard disk storing the program (a program downloaded from a memory medium such as a compact disc (CD) or a server or the like on the Internet in addition to a program stored from the stage of shipment of the device in advance), and a network connection interface. It should be apparent to those skilled in the art that various modification examples of the configuration method and the device are made.

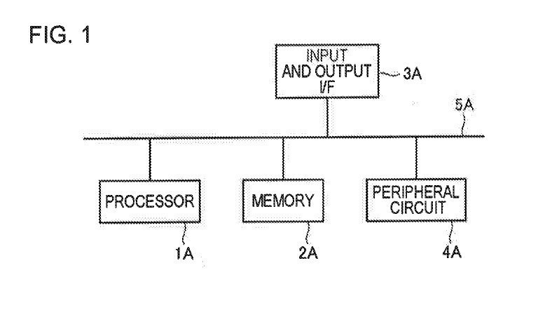

FIG. 1 is a block diagram illustrating an example of a hardware configuration of a device according to the example embodiment. As illustrated in FIG. 1, the device includes a processor 1A, a memory 2A, an input and output interface 3A, a peripheral circuit 4A, and a bus 5A. The peripheral circuit includes various modules.

The bus 5A is a data transmission path along which the processor 1A, the memory 2A, the peripheral circuit 4A, and the input and output interface 3A transmit and receive data one another. The processor 1A is, for example, an arithmetic processing device such as a central processing unit (CPU) or a graphics processing unit (GPU). The memory 2A is, for example, a memory such as a random access memory (RAM) or a read-only memory (ROM). The input and output interface 3A includes an interface along which information is acquired from an external device, an external server, an external sensor, or the like. The processor 1A gives an instruction to each module and performs an arithmetic operation on the basis of a calculation result.

Hereinafter, examples of reference forms are supplemented.

1. A control device including:

a reception unit that receives power generation relevant information related to a power generation situation of each of a plurality of power generation devices;

a calculation unit that calculates total differential power indicating a difference between a power generation output by the plurality of power generation devices and a target power generation output based on the received power generation relevant information; and

a transmission unit that transmits differential power information indicating the total differential power to a plurality of supply and demand adjustment control devices.

2. The control device described in 1,

in which the power generation relevant information indicates a power generation output of each of the plurality of power generation devices,

in which the reception unit receives the target power generation output of each of the power generation devices, and

in which the calculation unit calculates the total differential power based on the target power generation output and the power generation output of each of the plurality of power generation devices.

3. The control device described in 1,

in which the power generation relevant information is differential power indicating a difference between the power generation output in each of the plurality of power generation devices and the target power generation output, and

in which the calculation unit calculates the total differential power based on the differential power.

4. The control device described in any one of 1 to 3,

in which the calculation unit calculates a predicted value of the total differential power, and

in which the transmission unit transmits the differential power information based on the predicted value to the plurality of supply and demand adjustment control devices.

5. The control device described in 4,

in which the calculation unit calculates the predicted value of the total differential power based on a chronological change in the repeatedly calculated total differential power.

6. The control device described in any one of 1 to 5,

in which the target power generation output is a value calculated with a moving average of power generation outputs of the plurality of power generation devices.

7. The control device described in any one of 1 to 5,

in which the target power generation output is a value calculated based on a predetermined rate of change to the power generation output of each of the plurality of power generation devices.

8. The control device described in any one of 1 to 7,

in which the calculation unit calculates a sharing coefficient indicating a ratio at which each of a plurality of energy storage devices absorbs the total differential power based on state information related to each of the energy storage devices respectively controlled by the plurality of supply and demand adjustment control devices, and

in which the transmission unit transmits the sharing coefficient to the plurality of supply and demand adjustment control devices.

9. The control device described in 8,

in which the reception unit receives information indicating a suppression period of time in which power generation of the plurality of power generation devices is suppressed, and

in which the calculation unit selects the energy storage device before the suppression period of time and calculates the sharing coefficient.

10. The control device described in 9,

in which the calculation unit calculates the sharing coefficient based on an upper limit of total differential power which is a sum of differences between rated power generation outputs of the plurality of power generation devices, and the target power generation outputs, and the selected supply and demand adjustment control device.

11. The control device described in 9,

in which the calculation unit calculates the sharing coefficient corresponding to each of a case in which a sum of power generation outputs of the plurality of power generation devices is larger than a sum of the target power generation outputs of the plurality of power generation devices and a case in which the sum of power generation outputs is smaller than the sum of the target power generation outputs.

12. The control device described in 9,

in which the target power generation output is set for each of a plurality of the suppression periods of time, and

in which the calculation unit selects the energy storage device for each suppression period of time.

13. The control device described in 12,

in which the target power generation output and the plurality of energy storage devices are selected for each of the plurality of suppression periods of time, and

in which the calculation unit calculates the sharing coefficient for each suppression period of time.

14. The control device described in any one of 9 to 13,

in which the reception unit receives state information related to the energy storage device, and

in which the transmission unit transmits the sharing coefficient updated based on the state information to the supply and demand adjustment control device.

15. The control device described in any one of 8 to 14,

in which the transmission unit transmits the sharing coefficient to the supply and demand adjustment control device at a period longer than a period T1b at which the differential power information is transmitted.

16. The control device described in any one of 8 to 15,

in which the sharing coefficient in one energy storage device is a ratio of a chargeable and dischargeable capacity of the one energy storage device to a chargeable and dischargeable capacity of all the plurality of energy storage devices.

17. The control device described in any one of 1 to 16,

in which the differential power information is information for controlling charging and discharging of the energy storage device controlled by the supply and demand adjustment control device.

18. The control device described in any one of 1 to 17,

in which the transmission unit simultaneously transmits the differential power information to the plurality of supply and demand adjustment control devices.

19. The control device described in any one of 1 to 18,

in which the reception unit receives the power generation relevant information at a predetermined period, and

in which the transmission unit transmits the differential power information at the same period as the predetermined period or a period longer than the predetermined period.

20. A supply and demand adjustment control device including:

an adjustment-device-side reception unit that receives differential power information indicating total differential power which is a sum of differences between actually measured values of power generation outputs of a plurality of power generation devices and target power generation outputs of the power generation devices for each predetermined period; and

a control unit that controls an energy storage device based on the differential power information.

21. The supply and demand adjustment control device described in 20,

in which the adjustment-device-side reception unit receives a sharing coefficient indicating a ratio at which each of a plurality of the energy storage devices absorbs the total differential power, and

in which the control unit controls the energy storage device based on the differential power information and the sharing coefficient.

22. The supply and demand adjustment control device described in claim 21,

in which the control unit performs control such that the energy storage device absorbs a ratio indicated by the sharing coefficient in the total differential power.

23. The supply and demand adjustment control device described in any one of 20 to 22,

in which the differential power information is a predicted value of the differential power information calculated based on a chronological change in the differential power information.

24. The supply and demand adjustment control device described in any one of 20 to 23,

in which the adjustment-device-side reception unit receives the sharing coefficient before a suppression period of time in which power generation of the plurality of power generation devices is suppressed.

25. The supply and demand adjustment control device described in 24,

in which the target power generation output and the energy storage device are selected in each of a plurality of the suppression periods of time, and

in which the adjustment-device-side reception unit receives the sharing coefficient calculated for each suppression period of time.

26. The supply and demand adjustment control device described in 21,

in which the adjustment-device-side reception unit receives the sharing coefficient at a period longer than a period at which the differential power information is received, and

in which the control unit controls the energy storage device whenever the differential power information is received.

27. The supply and demand adjustment control device described in any one of 20 to 26, further including:

an adjustment-device-side transmission unit that transmits state information of the supply and demand adjustment control device,

in which the adjustment-device-side reception unit receives the sharing coefficient updated based on the transmitted state information.

28. The supply and demand adjustment control device described in any one of 20 to 27,

in which the adjustment-device-side reception unit receives the sharing coefficient which is a ratio of a chargeable and dischargeable capacity of one energy storage device to a chargeable and dischargeable capacity of all the plurality of energy storage devices.

29. The supply and demand adjustment control device described in any one of 20 to 28,

in which the control unit controls charging and discharging of the energy storage device based on the differential power information.

30. The supply and demand adjustment control device described in any one of 20 to 29,

in which the adjustment-device-side reception unit receives the simultaneously transmitted differential power information.

31. A power storage device including:

the supply and demand adjustment control device described in any one of 20 to 30 and a secondary battery.

32. A supply and demand adjustment system including:

the control device described in any one of 1 to 19; and

the supply and demand adjustment control device described in any one of 20 to 30.

33. An output control device including:

a reception unit that receives a target power generation output; and

a transmission unit that transmits differential power indicating a difference between a power generation output and the target power generation output.

34. The output control device described in 33,

in which the transmission unit transmits, instead of the difference, the differential power indicating a difference between a predicted value of the power generation output and the target power generation output.

35. A control method executed by a computer, the method including:

a reception step of receiving power generation relevant information related to a power generation situation of each of a plurality of power generation devices;

a calculation step of calculating total differential power indicating a difference between a power generation output by the plurality of power generation devices and a target power generation output based on the received power generation relevant information; and

a transmission step of transmitting differential power information indicating the total differential power to a plurality of supply and demand adjustment control devices.

36. A program causing a computer to functions as:

a reception unit that receives power veneration relevant information related to a power generation situation of each of a plurality of power generation devices;

a calculation unit that calculates total differential power indicating a difference between a power generation output by the plurality of power generation devices and a target power generation output based on the received power generation relevant information; and

a transmission unit that transmits differential power information indicating the total differential power to a plurality of supply and demand adjustment control devices.

37. A supply and demand adjustment method executed by a computer, the method including:

an adjustment-device-side reception step of receiving differential power information indicating total differential power which is a sum of differences between actually measured values of power generation outputs of a plurality of power generation devices and target power outputs of the power generation devices for each predetermined period; and

a control step of controlling an energy storage device based on the differential power information.

38. A program causing a computer to function as:

an adjustment-device-side reception unit receives differential power information indicating total differential power which is a sum of differences between actually measured values of power generation outputs of a plurality of power generation devices and target power outputs of the power generation devices for each predetermined period; and

a control unit that controls an energy storage device based on the differential power information.

1. A control device comprising:
a reception unit that receives power generation relevant information related to a power generation situation of each of a plurality of power generation devices;
a calculation unit that calculates total differential power indicating a difference between a power generation output by the plurality of power generation devices and a target power generation output based on the received power generation relevant information; and
a transmission unit that transmits differential power information indicating the total differential power to a plurality of supply and demand adjustment control devices.

2. The control device according to claim 1,
wherein the power generation relevant information indicates a power generation output of each of the plurality of power generation devices,
wherein the reception unit receives the target power generation output of each of the power generation devices, and
wherein the calculation unit calculates the total differential power based on the target power generation output and the power generation output of each of the plurality of power generation devices.

3. The control device according to claim 1,
wherein the power generation relevant information is differential power indicating a difference between the power generation output in each of the plurality of power generation devices and the target power generation output, and
wherein the calculation unit calculates the total differential power based on the differential power.

4. The control device according to claim 1,
wherein the calculation unit calculates a predicted value of the total differential power, and
wherein the transmission unit transmits the differential power information based on the predicted value to the plurality of supply and demand adjustment control devices.

5. The control device according to claim 4,
wherein the calculation unit calculates the predicted value of the total differential power based on a chronological change in the repeatedly calculated total differential power.

6. The control device according to claim 1,
wherein the target power generation output is a value calculated with a moving average of power generation outputs of the plurality of power generation devices.

7. The control device according to claim 1,
wherein the target power generation output is a value calculated based on a predetermined rate of change to the power generation output of each of the plurality of power generation devices.

8. The control device according to claim 1,
wherein the calculation unit calculates a sharing coefficient indicating a ratio at which each of a plurality of energy storage devices absorbs the total differential power based on state information related to each of the energy storage devices respectively controlled by the plurality of supply and demand adjustment control devices, and
wherein the transmission unit transmits the sharing coefficient to the plurality of supply and demand adjustment control devices.

9. The control device according to claim 8,
wherein the reception unit receives information indicating a suppression period of time in which power generation of the plurality of power generation devices is suppressed, and
wherein the calculation unit selects the energy storage device before the suppression period of time and calculates the sharing coefficient.

10. The control device according to claim 9,
wherein the calculation unit calculates the sharing coefficient based on an upper limit of total differential power which is a sum of differences between rated power generation outputs of the plurality of power generation devices, and the target power generation outputs, and the selected supply and demand adjustment control device.

11. The control device according to claim 9,
wherein the calculation unit calculates the sharing coefficient corresponding to each of a case in which a sum of power generation outputs of the plurality of power generation devices is larger than a sum of the target power generation outputs of the plurality of power generation devices and a case in which the sum of power generation outputs is smaller than the sum of the target power generation outputs.

12. The control device according to claim 9,
wherein the target power generation output is set for each of a plurality of the suppression periods of time, and
wherein the calculation unit selects the energy storage device for each suppression period of time.

13. The control device according to claim 12,
wherein the target power generation output and the plurality of energy storage devices are selected for each of the plurality of suppression periods of time, and
wherein the calculation unit calculates the sharing coefficient for each suppression period of time.

14. The control device according to claim 9,
wherein the reception unit receives state information related to the energy storage device, and
wherein the transmission unit transmits the sharing coefficient updated based on the state information to the supply and demand adjustment control device.

15. The control device according to claim 8,
wherein the transmission unit transmits the sharing coefficient to the supply and demand adjustment control device at a period longer than a period T1b at which the differential power information is transmitted.

16. The control device according to claim 8,
wherein the sharing coefficient in one energy storage device is a ratio of a chargeable and dischargeable capacity of the one energy storage device to a chargeable and dischargeable capacity of all the plurality of energy storage devices.

17. The control device according to claim 1,
wherein the differential power information is information for controlling charging and discharging of the energy storage device controlled by the supply and demand adjustment control device.

18. The control device according to claim 1,
wherein the transmission unit simultaneously transmits the differential power information to the plurality of supply and demand adjustment control devices.

19. The control device according to claim 1,
wherein the reception unit receives the power generation relevant information at a predetermined period, and
wherein the transmission unit transmits the differential power information at the same period as the predetermined period or a period longer than the predetermined period.

20.-38. (canceled)
